(19) United States
(12) Patent Application Publication
(10) Pub. No.: US 2009/0291293 A1
(43) Pub. Date: Nov. 26, 2009

(54) FILM WITH TRANSPARENT ELECTROCONDUCTIVE MEMBRANE AND ITS USE

(75) Inventor: Osamu Sakakura, Saitama-Ken (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 12/373,529

(22) PCT Filed: Jul. 13, 2007
(86) PCT No.: PCT/JP2007/063975

§ 371 Date: Jan. 13, 2009

(30) Foreign Application Priority Data
Jul. 14, 2006 (JP) 2006-194302
Jul. 14, 2006 (JP) 2006-194309
Feb. 7, 2007 (JP) 2007-028320

(51) Int. Cl. B32B 5/16

(52) U.S. Cl. 428/323

(57) ABSTRACT

This invention provides a film with a transparent electroconductive membrane, which can provide a display having a good surface flatness and possessing a high luminescence brightness, and a substrate for a display, a display, a liquid crystal display device, and an organic EL element using the film with a transparent electroconductive membrane. More specifically, this invention provides a film with a transparent electroconductive membrane, comprising a transparent base material and a transparent electroconductive membrane, the transparent electroconductive membrane having on its surface crystalline secondary particles having an average particle diameter of 0.1 to 1 μm in an amount of 1 to 100 particles/μm², and a substrate for a display, a display, a liquid crystal display device, and an organic EL element using the film with a transparent electroconductive membrane.

### TECHNICAL FIELD

The present invention relates to a film with a transparent electroconductive membrane. More specifically, the present invention relates to a highly transparent film with a transparent electroconductive membrane, which has a high total light transmittance and has suppressed coloring, a substrate for a display comprising the film with a transparent electroconductive membrane, a display, a liquid crystal display device, and an organic EL element.

### BACKGROUND ART

Various display-type displays have hitherto been used, and studies have been made on practice use of these displays. All the displays except for cathode ray tube types aim at thinning, and flexible displays have also become desired.

These have led to studies on the use of synthetic resin sheets or films instead of glass substrates which have hitherto constituted displays. Further, studies have also been made on substrates for displays using gas barrier films for cutting off oxygen and water vapor from the exterior, from the viewpoint of prolonging the service life of displays.

Synthetic resin films as materials for display substrates are required to have, in addition to mechanical strength, smoothness, gas barrier properties and the like, heat resistance or moisture resistance upon exposure to processing for stacking various layers for imparting a display function to synthetic resin films, or processing for providing a gas barrier layer. Conventional synthetic resin films, however, are significantly inferior in heat resistance or moisture resistance to glass substrates. Accordingly, deformation, for example, upon heating in the step of forming a thin metal film by vapor deposition or the like, or upon heating in the step of curing by heating after coating of a heat curable resin coating material, or deformation caused by moisture absorption upon contact with an aqueous solution in the step of etching a thin metal film or the step of developing a resist is unavoidable. Consequently, problems occur such as a deterioration in flatness of the formed display or gas barrier film, separation of the stacked thin metal film from the synthetic resin film caused by slippage of the stacked thin metal film, or deviation of the dimension of the assembly from a predetermined dimension. Further, in displays such as liquid crystal display panels or EL display panels, upon the contact of the formed element with water vapor, the performance of the element is deteriorated resulting in a problem, for example, that luminescence does not take place.

For this reason, the resistance to heat of 150° C. or above is required of gas barrier films for use in displays or substrates for displays, from the viewpoints of passing such a property that elongation or deflection derived from heat generation upon processing or during use or tension upon heating is less likely to occur, and enhancing the dimensional stability. In particular, in displays such as liquid crystal display panels or EL display panels, an ultrahigh level of gas barrier properties are required for preventing a deterioration in performance of the formed element upon contact, for example, with water vapor or oxygen.

Gas barrier films, which have hitherto been known in the art, comprise a gas barrier film provided on a polymeric resin base material, the gas barrier film having a two-layer structure of an inorganic compound deposited layer and a coating layer formed from a coating agent comprising a water/alcohol mixed solution as a main agent (see, for example, patent document 1).

Further, gas barrier laminated films known in the art comprise a gas barrier laminated film provided on a polymeric resin base material, the gas barrier laminated film having a two-layer structure of an inorganic compound deposited layer and a coating layer formed from a coating agent comprising, as a main agent, a mixed solution composed of a metal alkoxide or its hydrolyzate and an isocyanate compound (see, for example, patent document 2)

A technique is also known in which a gas shielding layer is formed by sputtering on a transparent heat-resistant base material (see, for example, patent document 3).

The films described in patent documents 1 to 3 have water resistance and moisture resistance, a flexibility enough to withstand a certain level of deformation, and gas barrier properties. For these films, however, as described in working examples, the oxygen permeability is approximately 1 cc/m²·day·atm, and, at best, the water vapor permeability and the oxygen permeability are approximately 0.1 g/m²·day and 0.3 cc/m²·day·atm, respectively. Thus, these films are disadvantageously unsatisfactory for preventing a deterioration, for example, in a luminescent layer in organic EL elements or the like. Further, there is no description about the resistance to heat of 150° C. or above, the chemical resistance and low linear expansion.

Patent document 1: Japanese Patent Laid-Open No. 164591/1995

Patent document 2: Japanese Patent Laid-Open No. 268115/1995

Patent document 3: Japanese Patent Laid-Open No. 222508/1999

### DISCLOSURE OF THE INVENTION

### Problems to be Solved by the Invention

When the surface flatness of a transparent electroconductive membrane is high, the chemical resistance, particularly acid resistance, is unsatisfactory, while, when the surface flatness is low, in some cases, a luminescent layer provided in contact with the transparent electroconductive membrane is damaged.

Further, in general, a transparent electroconductive membrane, when it has low surface resistivity, is likely to be colored. On the other hand, a transparent electroconductive membrane having suppressed coloring often has high surface resistivity. Thus, the production of a film with a transparent electroconductive membrane, which has a high total light transmittance and has suppressed coloring, that is, has a high level of transparency, and, at the same time, has low controlled surface resistivity, is not easy.

### Means for Solving the Problems

Thus, in a first aspect, the present invention relates to a film with a transparent electroconductive membrane, which can provide a display having good surface flatness and high luminescence brightness, a substrate for a display, comprising the film with a transparent electroconductive membrane, a display, a liquid crystal display device, and an organic EL element.

In a second aspect, the present invention provides a film with a transparent electroconductive membrane, which can simultaneously realize good surface resistivity and luminescence brightness and satisfactory light transmittance, heat resistance and gas barrier properties, and a substrate for a display and a display using the film with a transparent electroconductive membrane.

First Invention

The film with a transparent electroconductive membrane according to the first present invention, comprises a transparent base material and a transparent electroconductive membrane, the transparent electroconductive membrane having on its surface crystalline secondary particles having an average particle diameter of 0.1 to 1 μm in an amount of 1 to 100 particles/μm².

In a preferred embodiment of the first invention, the transparent electroconductive membrane in the film with a transparent electroconductive membrane contains crystalline secondary particles having an average particle diameter of 0.1 to 1 μm in an amount of 150 to 10000 particles/μm³.

In a preferred embodiment of the first invention, the half value width at the maximum peak angle in a crystal phase in the transparent electroconductive membrane in the film with a transparent electroconductive membrane is 1.5 to 9.5.

The substrate for a display according to the first invention, comprises the above film with a transparent electroconductive membrane.

The display according to the first invention, comprises the above substrate for a display.

The liquid crystal display device according to the first invention, comprises the substrate for a display.

The organic EL element according to the first invention, comprises the substrate for a display.

Second Invention

The film with a transparent electroconductive membrane according to the second invention, comprises a transparent base material and a transparent electroconductive membrane, the film having an extinction coefficient against light with a wavelength of 550 nm of not more than 0.05 and a yellowness (YI) of 0.5 to 3.0.

In a preferred embodiment of the second invention, the film with a transparent electroconductive membrane has a total light transmittance of not less than 75%.

In a preferred embodiment of the second invention, the transparent electroconductive membrane in the film with a transparent electroconductive membrane has been formed by repeating a plurality of times the step of conducting any one of plasma treatment, ion bombardment treatment, glow discharge treatment, arc discharge treatment, and spray treatment in an oxidizing gas every time when each 0.3 to 10 nm-thick transparent electroconductive membrane is formed, and accumulating the transparent electroconductive thin film formed in each treatment.

In a preferred embodiment of the second invention, the film with a transparent electroconductive membrane comprises a first gas barrier layer.

In a preferred embodiment of the second invention, the film with a transparent electroconductive membrane further comprises a first smoothing layer.

In a preferred embodiment of the second invention, the film with a transparent electroconductive membrane further comprises a second gas barrier layer.

In a preferred embodiment of the second invention, the film with a transparent electroconductive membrane further comprises a second smoothing layer.

In a preferred embodiment of the second invention, the first smoothing layer in the film with a transparent electroconductive membrane is formed of an ionization radiation cured resin.

In a preferred embodiment of the second invention, the first gas barrier layer and/or the second gas barrier layer in the film with a transparent electroconductive membrane are formed of any one material selected from the group consisting of inorganic oxides, inorganic oxynitrides, inorganic oxycarbides, or inorganic oxynitrocarbides.

In a preferred embodiment of the second invention, the first smoothing layer and/or the second smoothing layer in the film with a transparent electroconductive membrane are a layer containing a cardo polymer, a layer containing a polymer having an acryl skeleton, a layer, which is a coating film formed from a coating composition comprising as components at least a silane coupling agent containing an organic functional group and a hydrolyzable group, and a crosslinkable compound containing an organic functional group reactive with the organic functional group contained in the silane coupling agent, or a layer containing a polymer having an epoxy skeleton.

In a preferred embodiment of the second invention, the film with a transparent electroconductive membrane has a water vapor permeability of not more than 0.05 g/m²/day.

The substrate for a display according to the second invention, comprises the above film with a transparent electroconductive membrane.

The display according to the second invention, comprises the above substrate for a display.

The liquid crystal display device according to the second invention, comprises the above substrate for a display.

The organic EL element according to the second invention, comprises the above substrate for a display.

### EFFECT OF THE INVENTION

The film with a transparent electroconductive membrane according to the first invention comprises a transparent base material and a transparent electroconductive membrane, the transparent electroconductive membrane having on its surface crystalline secondary particles having an average particle diameter of 0.1 to 1 μm in an amount of 1 to 100 particles/μm². By virtue of the above constitution, the film with a transparent electroconductive membrane according to the first invention can provide a display having a good surface flatness and a high luminescence brightness, and a substrate for a display, a display, a liquid crystal display device, and an organic EL element using the film with a transparent electroconductive membrane.

The film with a transparent electroconductive membrane according to the first invention has excellent acid resistance.

The film with a transparent electroconductive membrane according to the second invention comprises a transparent base material and a transparent electroconductive membrane, the film having an extinction coefficient against light with a wavelength of 550 nm of not more than 0.05 and a yellowness (YI) of 0.5 to 3.0. By virtue of the above constitution, the film with a transparent electroconductive membrane according to the second invention has low visible light absorption and high transparency. Accordingly, if necessary, other layers such as a gas barrier layer may be formed. Further, a plurality of these layers may be formed, or layers having a satisfactory thickness can be formed. Therefore, for example, gas barrier properties, heat resistance, and smoothness can be improved while maintaining satisfactory transparency.

The film with a transparent electroconductive membrane according to the second invention is particularly suitable as a film substrate for a display and is further useful for touch panels, film substrates for lighting, film substrates for solar batteries, film substrates for circuit boards, electronic papers and the like.

### BRIEF DESCRIPTION OF THE DRAWINGS

FIG. 1 is a cross-sectional view of a particularly preferred embodiment of the film with a transparent electroconductive membrane according to the present invention.

FIG. 2 is a cross-sectional view of a particularly preferred embodiment of the film with a transparent electroconductive membrane according to the present invention.

FIG. 3 is a cross-sectional view of a particularly preferred embodiment of the film with a transparent electroconductive membrane according to the present invention.

### DESCRIPTION OF REFERENCE CHARACTERS

1: film with transparent electroconductive membrane,
10: transparent base material,
11: transparent electroconductive membrane,
13: gas barrier layer,
14: smoothing layer, and
15: auxiliary electrode layer.

### BEST MODE FOR CARRYING OUT THE INVENTION

### First Invention

<Film with Transparent Electroconductive Membrane>

The film with a transparent electroconductive membrane according to the first invention, comprises a transparent base material and a transparent electroconductive membrane, the transparent electroconductive membrane having on its surface crystalline secondary particles having a particle diameter of 0.1 to 1 μm in an amount of 1 to 100 particles/μm².

The film with a transparent electroconductive membrane, comprising a transparent base material and a transparent electroconductive membrane, according to the present invention is not limited to only (i) a film with a transparent electroconductive membrane, comprising a single layer of a transparent base material and a single layer of a transparent electroconductive membrane, and includes, for example, (ii) a film with a transparent electroconductive membrane, comprising a single layer or a plurality of layers of a transparent base material and a single or a plurality of layers of a transparent electroconductive membrane, wherein any one of or both the transparent base material and the transparent electroconductive membrane are provided plurally, and (iii) a film with a transparent electroconductive membrane having the same construction as the film (i) or (ii) except that a layer or a material other than the transparent base material and the transparent electroconductive membrane is further formed singly or plurally. Specific examples of preferred layers or materials other than the transparent base material and the transparent electroconductive membrane include, for example, a gas barrier layer and a smoothing layer which will be described later.

Further, it should be noted that, in the film with a transparent electroconductive membrane according to the present invention, the transparent electroconductive membrane is not always evenly formed on substantially the whole surface of the transparent base material. Accordingly, the film with a transparent electroconductive membrane according to the present invention include, for example, one in which a transparent electroconductive membrane is partially formed on the transparent base material, for example, one in which the transparent electroconductive membrane is formed in a pattern form on the transparent base material.

Preferably, the total light transmittance of the film with a transparent electroconductive membrane according to the present invention is not less than 75%, particularly preferably not less than 80%. The total light transmittance is as specified in according to JIS K 7361-1.

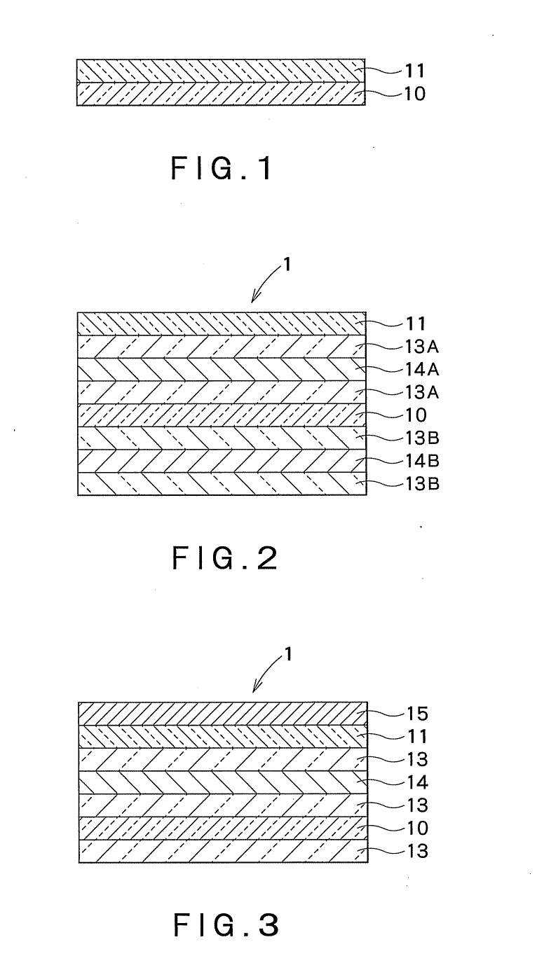

FIGS. 1 and 2 show particularly preferred embodiments of the film with a transparent electroconductive membrane according to the present invention. The film with a transparent electroconductive membrane according to the present invention shown in FIG. 1 has a layer construction of “transparent base material 10/transparent electroconductive membrane 11” as viewed from the lowermost layer. The film 1 with a transparent electroconductive membrane according to the present invention shown in FIG. 2 has a layer construction of “second gas barrier layer 13B/second smoothing layer 14B/second gas barrier layer 13B/transparent base material 10/first gas barrier layer 13A/first smoothing layer 14A/first gas barrier layer 13A/transparent electroconductive membrane 11” as viewed from the lowermost layer. The substrate for a display according to the present invention shown in FIG. 3 has a layer construction of “gas barrier layer 13/transparent base material 10/gas barrier layer 13/smoothing layer 14/gas barrier layer 13/transparent electroconductive layer 11/auxiliary electrode layer 15”.

Each layer constituting the film 1 with a transparent electroconductive membrane according to the present invention shown in FIG. 2 will be described.

(1) Transparent Electroconductive Membrane

A transparent electroconductive membrane 11 may be a coating layer composed mainly of an inorganic oxide formed by coating a hydrolyzate of a metal alkoxide or the like or by coating transparent electroconductive particles and a hydrolyzate of a metal alkoxide or the like, or may be a membrane formed by a vacuum film forming method such as resistance heating vapor deposition, induction heating vapor deposition, EB vapor deposition, sputtering, ion plating, thermal CVD, or plasma CVD. The EB vapor deposition, sputtering, and ion plating using an apparatus construction, which can provide a low-resistance and surface treatable transparent electroconductive membrane, are particularly preferred. The material for the transparent electroconductive membrane is properly selected from indium-tin-base oxide (ITO), indium-tin-zinc-base oxide (ITZO), ZnO₂-based materials, CdO-based materials, SnO₂-based materials and the like. Among others, indium-tin-base oxide (ITO) is preferred from the viewpoint of excellent transparency and electroconductivity. In particular, the content of tin in the indium-tin-base oxide (ITO) is preferably 5 to 15% by mole. The thickness of the indium-tin-base oxide (ITO) membrane is preferably 10 nm to 1000 nm, more preferably 60 nm to 450 nm, still more preferably 100 to 200 nm. When the thickness is less than 10 nm, the electroconductivity of the transparent electroconductive membrane used as the transparent electrode layer is unsatisfactory. On the other hand, when the thickness exceeds 1000 nm, disadvantageously, the transparency and flex resistance are deteriorated. The indium-tin-base oxide (ITO) membrane may be noncrystalline or crystalline or alternatively may have an intermediate between noncrystalline and crystalline properties (a mixed type). In the formation of the membrane according to the present invention, the mixed type is better.

In the present invention, preferably, the transparent electroconductive membrane contains crystalline secondary particles having an average particle diameter of 0.1 to 0.5 μm at a density of 1 to 100 particles/μm². The particle diameter of the crystalline secondary particles is particularly preferably 0.1 to 0.3 μm, and the density of such particles is preferably 3 to 80 particles/μm². When the particle diameter and the density fall within the above-defined respective ranges, the level of surface concavoconvexes (maximum elevation difference of the surface) is small. The density is more preferably 1.5 to 35 particles/μm². When the density falls within this range, the surface roughness Ra is small. When these requirements are satisfied, shortcircuiting attributable to projections of the transparent electroconductive membrane in image display devices such as organic EL elements is less likely to occur. The crystalline particle is specifically a particle which has been determined to be crystalline by measurement with an automatic X-ray diffractometer RINT 2000 manufactured by Rigaku Corporation. The particle diameter can easily be determined according to JIS B 0601 by observation with Nanopics 1000 (tradename: manufactured by Seiko Instruments Inc.), and the density can easily be determined by taking into consideration the measurement range in the measurement of the particle diameter. In the ITO membrane, preferably, the (222) face exhibits the maximum peak, and the half-value width is 1.5 to 9.5, particularly preferably 2.0 to 8.3, more preferably 2.5 to 6.0. The maximum peak of the crystal phase is calculated with RINT 2000/PC Series (tradename: manufactured by Rigaku Corporation).

The transparent electroconductive membrane according to the present invention can have desired electrical resistivity and can be prepared so as to have an electrical resistivity in the range of 0.5×10⁻⁴ to 10³Ω·cm.

In the formation of the preferred transparent electroconductive membrane, any method may be adopted so far as crystalline secondary particles having the above particle diameter and density are formed. In the present invention, preferably, instead of a method in which a transparent electroconductive membrane having a finally necessary thickness is formed in a single continuous step, a method is adopted in which the transparent electroconductive membrane is formed through a plurality of divided steps, while accumulating the transparent electroconductive membrane formed in each unit transparent electroconductive membrane formation, in which, after the formation of each transparent electroconductive membrane, treatment with an oxidizing gas is carried out.

In the present invention, a method is particularly preferably adopted in which a transparent electroconductive membrane is formed in a thickness of 0.3 to 10 nm per unit transparent electroconductive membrane formation, and, every time when the 0.3 to 10 nm-thick transparent electroconductive membrane is formed, the step of subjecting the assembly to any one of plasma treatment, ion bombardment treatment, glow discharge treatment, arc discharge treatment, and spray treatment is carried out a plurality of times in an oxidizing gas, while accumulating the transparent electroconductive membrane formed in each unit transparent electroconductive membrane formation.

When the thickness of the transparent electroconductive membrane per unit transparent electroconductive membrane formation is less than 0.3 nm, disadvantageously, the growth of crystals is unsatisfactory and, further, the electroconductivity is lowered. On the other hand, when the thickness of the transparent electroconductive membrane per unit transparent electroconductive membrane formation exceeds 10 nm, excessive crystal growth proceeds, disadvantageously resulting in large surface roughness. The thickness of the transparent electroconductive membrane per unit transparent electroconductive membrane formation is particularly preferably 0.5 to 10 nm. In this connection, it should be noted that, in each unit transparent electroconductive membrane formation, a transparent electroconductive membrane having an identical thickness may be formed, or alternatively a transparent electroconductive membrane having a different thickness may be formed. The same effect as described above can also be attained by regulating the temperature of the substrate on which the transparent electroconductive membrane is formed.

In the present invention, when a vacuum film formation method is adopted, the apparatus for use in the transparent electroconductive membrane formation is preferably an apparatus which can alternately perform membrane formation and annealing, for example, an apparatus comprising a plurality of coating parts and a drum-type apparatus.

(2) Transparent Base Material

A synthetic resin film which has hitherto been used as a material for a display substrate may be used as a transparent base material 10 in the film 1 with a transparent electroconductive membrane according to the present invention. In the present invention, a synthetic resin film having a total light transmittance of 60 to 99%, preferably 80 to 95%, is preferred. The thickness of the base material may be properly determined depending, for example, upon specific applications of the film with a transparent electroconductive membrane. The thickness of the base material, however, is preferably 12 to 300 μm, particularly preferably 50 to 200 μm. The transparency is defined by the total light transmittance. In the film 1 with a transparent electroconductive membrane according to the present invention, conventional resin layers called an easy-adhesion layer, an adhesion accelerating layer, a primer layer, an undercoating layer, or an anchor coating layer may be formed on the transparent base material 10 in its first gas barrier layer 13A or second gas barrier layer 13B forming surface, from the viewpoint of improving the wettability and adhesion between the transparent base material 10 and the gas barrier layer.

Specific examples of preferred resin films usable as the base material film include films of crystalline resins, for example, thermoplastic resins, such as polyamides, polyacetals, polybutylene terephthalates, polyethylene terephthalates, polyethylene naphthalates, or syndiotactic polystyrenes, and heat curable resins such as polyphenylene sulfides, polyether ether ketones, liquid crystal polymers, fluororesins, or polyether nitrites. Examples of synthetic resins, which are more preferred resins, as materials for constituting the base material films include noncrystalline resins, for example, thermoplastic resins such as polycarbonates, modified polyphenylene ethers, polycyclohexenes, or polynorbornene resins, and heat curable resins such as polysulfones, polyethersulfones, polyarylates, polyamide imides, polyether imides, or thermoplastic polyimides. Among them, polycarbonates are particularly preferred because, by virtue of their low water absorption, base material films formed by the polycarbonate have a low coefficient of moisture expansion.

The loaded deflection temperature is a more practical index for thermal properties required of the base material film, particularly behavior against external force and is specified in JIS K 7191. Examples of loaded deflection temperatures for respective resins are 155° C. for polyethylene naphthalate resin (PEN), 160° C. for polycarbonate resin, 175° C. for polyarylate resin, 210° C. for polyethersulfone resin, 150° C. for cycloolefin polymer (manufactured by Zeon Corporation, tradename; “ZEONOR”), and 155° C. for norbornene resin (manufactured by JSR Corporation, tradename; “ARTON”).

When the film constituting a base material film 10 layer is a polyester, a linear saturated polyester synthesized from an aromatic dibasic acid or its ester forming derivative and a diol or its ester forming derivative is preferred as the polyester. Some conventional polyesters have a loaded deflection temperature of 150° C. or below. The polyester as the base material film 10 layer referred to herein is a polyester having a loaded deflection temperature of 150° C. or above. Specific examples of polyesters include polyethylene terephthalate, polyethylene isophthalate, polyethylene isophthalate, polybutylene terephthalate, poly(1,4-cyclohexylene dimethylene terephthalate), and polyethylene-2,6-naphthalate. The polyester may also be a copolymer of the above polymers or a blend of the above polymers with a minor proportion of other resins. Among these polyesters, polyethylene terephthalate and polyethylene-2,6-naphthalate are preferred because of a good balance between kinetic properties, optical properties and the like. In particular, polyethylene-2,6-naphthalate is superior to polyethylene terephthalate, for example, in large mechanical strength, small thermal shrinkage, small amount of oligomer production upon heating. Further, polyethylene-2,6-naphthalate has high chemical resistance. Accordingly, also in a method including an etching step, for example, when a pattern layer is formed by etching using a resist followed by gas barrier membrane formation, advantageously, for example, the surface of the polyethylene naphthalate resin film is not significantly deteriorated and, thus, a gas barrier membrane and the like can be stably formed to impart excellent gas barrier properties.

The polyester may be a homopolymer or a copolymer using a third comonomer component, preferably a homopolymer. When the polyester is polyethylene terephthalate, an isophthalic acid-copolymerized polyethylene terephthalate is best suited as the copolymer. The content of isophthalic acid in the isophthalic acid-copolymerized polyethylene terephthalate is preferably not more than 5% by mol. In the polyester, a comonomer component other than isophthalic acid or a comonomer alcohol component may be copolymerized in such an amount that does not sacrifice the properties of the polyester, for example, in an amount of not more than 3% by mole based on the whole acid component or the whole alcohol component. Examples of such comonomer acid components include aromatic dicarboxylic acids such as phthalic acid and 2,6-naphthalenedicarboxylic acid, and aliphatic dicarboxylic acids such as adipic acid, azelaic acid, sebacic acid, and 1,10-decanedicarboxylic acid. Examples of alcohol components include aliphatic diols such as 1,4-butanediol, 1,6-hexanediol, and neopentyl glycol, and alicyclic diol such as 1,4-cyclohexane dimethanol. They may be used solely or in a combination of two or more.

When the polyester is polyethylene-2,6-naphthalene dicarboxylate, naphthalenedicarboxylic acid is used as a main dicarboxylic acid component and ethylene glycol is used as a main glycol component. Naphthalenedicarboxylic acids include, for example, 2,6-naphthalenedicarboxylic acid, 2,7-naphthalenedicarboxylic acid, and 1,5-naphthalenedicarboxylic acid. Among them, 2,6-naphthalenedicarboxylic acid is preferred. The term “main” as used herein means at least 90% by mole, preferably at least 95% by mole, of the total repeating units in the constituents of the polymer as the component of the film according to the present invention.

(3) Smoothing Layer

In the film 1 with a transparent electroconductive membrane according to the present invention, if necessary, a first smoothing layer 14A and a second smoothing layer 14B (collectively referred to as “smoothing layer 14”) may be provided on the surface of the gas barrier layer 13. A sol-gel material, an ionizing radiation curable resin, a heat curable resin, a photoresist material may also be used for the formation of the smoothing layer 14 so far as these materials are coated for flattening the surface of the assembly. Preferably, however, the smoothing layer 14 is formed from a material which can impart a gas barrier function and has excellent coatability. The use of the ionizing radiation curable resin is preferred from the viewpoint of improving the coatability. In this case, the smoothing layer may be formed by coating a resin, which, upon exposure to ultraviolet light (UV) or electron beams (EB), induces a crosslinking polymerization reaction for conversion to a three-dimensional polymer structure, that is, an ionizing radiation curable resin into which a reactive prepolymer, an oligomer, and/or a monomer containing a polymerizable unsaturated bond or an epoxy group in its molecule has been properly mixed, or a liquid composition produced by optionally mixing a thermoplastic resin such as a urethane, polyester, acryl, butyral, or vinyl resin into the ionizing radiation curable resin in consideration of coatability and the like and bringing the resin to a liquid, by a well-known coating method such as roll coating, Mayer bar coating, or gravure coating and drying and curing the coating.

The thickness of the smoothing layer may be properly determined depending, for example, upon specific applications of the film with a transparent electroconductive membrane and is preferably 0.05 to 10 μm, particularly preferably 0.1 to 5 μm.

Ionizing Radiation Curable Resin

Suitable specific ionizing radiation curable resins are those containing an acrylate-type functional group, that is, those having an acryl skeleton or epoxy skeleton. When the hardness, heat resistance, solvent resistance, and scratch resistance of the coating film are taken into consideration, a structure having a high crosslinking density is preferred. In this case, preferred are bi- or higher functional acrylate monomer, for example, ethylene glycol di(meth)acrylate, 1,6-hexanediol diacrylate, trimethylolpropane tri(meth)acrylate, pentaerythritol tri(meth)acrylate, dipentaerythritol penta(meth)acrylate, and dipentaerythritol hexa(meth)acrylate. In the above description, “(meth)acrylate” means both acrylate and methacrylate.

The ionizing radiation curable resin is satisfactorily cured upon exposure to electron beams. When the application of ultraviolet light for curing is contemplated, photopolymerization initiators, for example, acetophenones, benzophenones, thioxanthones, benzoins, benzoin methyl ether, Michler's benzoyl benzoate, Michler's ketone, diphenyl sulfide, dibenzyl disulfide, diethyl oxide, triphenyl bisimidazole, and isopropyl-N,N-dimethylaminobenzoate, and photosensitizers, for example, n-butylamine, triethylamine, and poly-n-butylphosphine are preferably used solely or as a mixture of two or more. The addition amount of the photopolymerization initiator or photosensitizer is generally about 0.1 to 10 parts by weight based on 100 parts by weight of the ionizing radiation curable resin. If necessary, various inorganic or organic additives such as silane compounds other than the above compounds, solvents, curing catalysts, wetting improvers, plasticizers, antifoaming agents, and thickeners may be added to the coating material composition.

The coverage of the coating material composition is suitably approximately 0.5 to 15 g/m² on a solid basis. Light sources such as ultrahigh-pressure mercury lamps, high-pressure mercury lamps, low-pressure mercury lamps, carbon arc lamps, backlight fluorescent lamps, and metal halide lamps are usable as the ultraviolet light source for curing. The wavelength of the ultraviolet light may be in the range of 190 to 380 nm. Various electron beam accelerators, for example, Cockcroft-Walton accelerators, van de Graaff accelerators, resonance transformers, insulated core transformers, and linear, dynamitron and high-frequency electron accelerators are usable as the electron beam source.

Sol-Gel Method

For example, in order to provide good adhesion between the smoothing layer and the barrier layer, a sol-gel material using a sol-gel method, which can form coating films of an identical material, is preferred as the material for the smoothing layer in the present invention.

The sol-gel method refers to a method for coating a coating material composition, or a coating film, comprising, as raw materials, at least a silane coupling agent containing an organic functional group and a hydrolyzable group and a crosslinkable compound containing an organic functional group reactive with the organic functional group possessed by the silane coupling agent. Aminoalkyldialkoxysilanes or aminoalkyltrialkoxysilanes represented by general formula (a) disclosed, for example, in Japanese Patent Laid-Open No. 207130/2001 are preferred as the silane coupling agent containing an organic functional group and a hydrolyzable group (hereinafter often referred to simply as “silane coupling agent”).

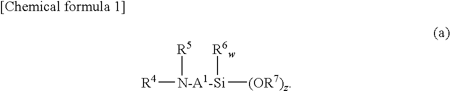

wherein A¹ represents an alkylene group; R⁴ represents a hydrogen atom, a lower alkyl group, or a group represented by general formula (b); R⁵ represents a hydrogen atom or a lower alkyl group; R⁶ represents an alkyl group having 1 to 4 carbon atoms, an aryl group, or an unsaturated aliphatic residue, and, when a plurality of R⁶s are present in its molecule, they may be the same or different; R⁷ represents a hydrogen atom, an alkyl group having 1 to 4 carbon atoms, or an acyl group, preferably a hydrogen atom, an alkyl group having 1 to 3 carbon atoms, or an acyl group, and, when a plurality of R⁷s are present in its molecule, they may be the same or different; and w is 0 (zero), 1, or 2 and z is an integer of 1 to 3, provided that w+z=3; and

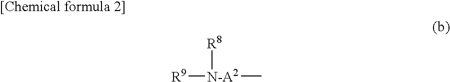

wherein A² represents a direct bond or an alkylene group; R⁸ and R⁹ each independently represent a hydrogen atom or a lower alkyl group; and at least one of R⁴, R⁵, R⁸, and R⁹ represents a hydrogen electron.

Specific examples of aminoalkyldialkoxysilanes or aminoalkyltrialkoxysilanes represented by formula (a) include N-β(aminoethyl)γ-aminopropyltrimethoxysilane, N-β(aminoethyl)γ-aminopropyltriethoxysilane, N-β(aminoethyl)γ-aminopropyltriisopropoxysilane, N-β(aminoethyl)γ-aminopropyltributoxysilane, N-β(aminoethyl)γ-aminopropylmethyldimethoxysilane, N-β(aminoethyl)γ-aminopropylmethyldiethoxysilane, N-β(aminoethyl)γ-aminopropylmethyldiisopropoxysilane, N-β(aminoethyl)γ-aminopropylmethyldibutoxysilane, N-β(aminoethyl)γ-aminopropylethyldimethoxysilane, N-β(aminoethyl)γ-aminopropylethyldiethoxysilane, N-β(aminoethyl)γ-aminopropylethyldiisopropoxysilane, N-β(aminoethyl)γ-aminopropylethyldibutoxysilane, γ-aminopropyltrimethoxysilane, γ-aminopropyltriethoxysilane, γ-aminopropyltriisopropoxysilane, γ-aminopropyltributoxysilane, γ-aminopropylmethyldimethoxysilane, γ-aminopropylmethyldiethoxysilane, γ-aminopropylmethyldiisopropoxysilane, γ-aminopropylmethyldibutoxysilane, γ-aminopropylethyldimethoxysilane, γ-aminopropylethyldiethoxysilane, γ-aminopropylethyldiisopropoxysilane, γ-aminopropylethyldibutoxysilane, and γ-aminopropyltriacetoxysilane. They may be used solely or in a combination of two or more.

The “crosslinkable compound containing an organic functional group reactive with the organic functional group possessed by the silane coupling agent” (hereinafter referred to simply as “crosslinkable compound”) is a crosslinkable compound containing a functional group reactive with an amino group, for example, a glycidyl group, a carboxyl group, an isocyanate group, or an oxazoline group, and specific examples thereof include diglycidyl ethers such as ethylene glycol diglycidyl ether, diethylene glycol diglycidyl ether, triethylene glycol diglycidyl ether, tetraethylene glycol diglycidyl ether, nenoethylene glycol diglycidyl ether, propylene glycol diglycidyl ether, dipropylene glycol diglycidyl ether, tripropylene glycol diglycidyl ether, 1,6-hexane diol diglycidyl ether, neopentyl glycol diglycidyl ether, adipic acid diglycidyl ether, o-phthalic acid diglycidyl ether, and glycerol diglycidyl ether; triglycidyl ethers such as glycerol triglycidyl ether, digylcerol triglycidyl ether, triglycidyl tris(2-hydroxyethyl)isocyanurate, and trimethylolpropane triglycidyl ether; tetraglycidyl ethers such as pentaerythritol tetraglycidyl ether; other polyglycidyl ethers or polymers containing a glycidyl group as a functional group; dicarboxylic acids such as tartaric acid and adipic acid; carboxyl group-containing polymers such as polyacrylic acid; isocyanates such as hexamethylene diisocyanate and xylylene diisocyanate; oxazoline-containing polymers; and alicyclic epoxidized compounds. They may be used solely or in a combination of two or more. Compounds containing two or more glycidyl groups are preferred from the viewpoint of reactivity.

The amount of the crosslinkable compound used is preferably 0.1 to 300% (by mass; the same shall apply hereinafter), more preferably 1 to 200%, based on the silane coupling agent. When the amount of the crosslinkable compound used is less than 0.1%, the flexibility of the coating film is unsatisfactory. On the other hand, when the amount of the crosslinkable compound used is more than 300%, there is a possibility that the gas barrier properties are deteriorated. The silane coupling agent and the crosslinkable compound are stirred optionally while heating to prepare a coating material composition.

When the coating material composition comprising a silane coupling agent and a crosslinkable compound as raw material is coated on the thin-film layer followed by drying, the hydrolysis and condensation of the silane coupling agent and crosslinking by the crosslinkable compound proceed to form a coating film of polysiloxane having a crosslinked structure.

The above composition may further contain a silane compound which contains a hydrolyzable group and is free from an organic functional group such as an amino group.

Specific examples of such silane compounds include tetramethoxysilane, tetraethoxysilane, tetraisopropoxysilane, tetrabutoxysilane, methyltrimethoxysilane, methyltriethoxysilane, methyltriisopropoxysilane, methyltributoxysilane, ethyltrimethoxysilane, ethyltriethoxysilane, ethyltriisopropoxysilane, ethyltributoxysilane, dimethyldimethoxysilane, dimethyldiethoxysilane, dimethyldiisopropoxysilane, dimethyldibutoxysilane, diethyldimethoxysilane, diethyldiethoxysilane, diethyldiisopropoxysilane, diethyldibutoxysilane, vinyltrimethoxysilane, vinyltriethoxysilane, γ-glycidopropyltrimethoxysilane, γ-glycidopropyltriethoxysilane, γ-methacryloxypropyltrimethoxysilane, γ-chloropropyltrimethoxysilane, and γ-mercaptopropyltrimethoxysilane. They may be used solely or in a combination of two or more.

When the silane compound, which contains a hydrolyzable group and is free from an organic functional group such as an amino group, is contained, the cohydrolysis condensation of the silane compound with a silane coupling agent, which contains a hydrolyzable group and an organic functional group such as an amino group, and crosslinking by the crosslinkable compound proceed to form a coating film of polysiloxane having a crosslinked structure.

The coating material composition may further contain a silane coupling agent containing an organic functional group such as an amino group and a hydrolyzable group and/or a (co)hydrolysis condensate of a silane compound, which contains a hydrolyzable group and is free from an organic functional group such as an amino group. If necessary, various inorganic or organic additives such as silane compounds other than the above compounds, solvents, curing catalysts, wetting improvers, plasticizers, antifoaming agents, and thickeners may be added to the coating material composition.

Cardo Polymer

The material for the smoothing layer preferably contains a cardo polymer. The cardo polymer is a polymer having the following cardo structure and is synthesized from a monomer having a cardo structure and other polymerizable monomer. For example, cardo polyester polymers, a cardo acryl polymers, and cardo epoxy polymers can be applied. Among them, cardo epoxy polymers are preferred. The smoothing layer may contain the cardo polymer as a main component.

If necessary, additives such as plasticizers, fillers, antistatic agents, lubricants, antiblocking agents, antioxidants, ultraviolet absorbers, and photostabilizers, and, further, modifying resins may be added to the smoothing layer.

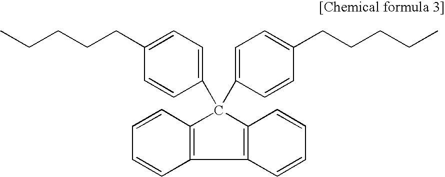

The cardo polymer has a unique structure called a cardo structure in a main chain skeleton of a polymer. The cardo structure contains a number of aromatic rings. Due to its steric hindrance, a fluorene skeleton moiety and the main chain direction are in a twist positional relationship. Accordingly, it is considered that the carbon atom part located in the center of the polymer can change a bond angle relatively freely and, thus, the cardo polymer is strong and tough and, despite such properties, does not become brittle even at low temperatures and further has high hardness and scratch resistance.

A layer containing the cardo polymer has good leveling properties and can fill and cover defects and, after drying, has higher surface smoothness. Further, the layer has good affinity and wetting properties for the inorganic compound (the gas barrier layer 13A according to the present invention) and thus can fill, cover and clog defects such as pores, concaves, and cracks. Accordingly, a very high smoothing function can be exhibited by synergistic effect of the affinity and the leveling properties, and smoothing, that is, surface Ra and Rmax can be significantly lowered.

Thus, when the surface smoothness is enhanced, gas is adsorbed on the surface of the material, is dissolved in the material, is diffused in the material, and is radiated toward the opposite side. Accordingly, the adsorption sites (surface area) of oxygen or water vapor can be reduced. Thus, the adsorption on the surface in the first stage can be significantly reduced, and the gas barrier properties can be significantly improved.

(4) Gas Barrier Layer

In the film 1 with a transparent electroconductive membrane according to the present invention, if necessary, gas barrier layers 13A and 13B (collectively referred to as “gas barrier layer 13”) may be provided on the cured resin layer. The material for the gas barrier layer 13 is not particularly limited so far as the material has gas barrier properties. Examples of such materials include metals such as aluminum, nickel, chromium, iron, cobalt, zinc, gold, silver, and copper; semiconductors such as silicon, germanium, and carbon; inorganic oxides such as silicon oxide, aluminum oxide, magnesium oxide, indium oxide, calcium oxide, zirconium oxide, titanium oxide, boron oxide, zinc oxide, cerium oxide, hafnium oxide, and barium oxide; nitrides such as silicon nitride, aluminum nitride, boron nitride, and magnesium nitride; carbides such as silicon carbide; and sulfides. Further, oxynitrides which are composites of two or more of the above materials, and, furthermore, carbon-containing compounds such as oxycarbides, inorganic carbonitrides, inorganic oxycarbonitrides and the like may also be applied.

Preferred are inorganic oxides (MOx) such as aluminum oxide, silicon oxide, magnesium oxide, calcium oxide, zirconium oxide, and titanium oxide, inorganic nitrides (MNy), inorganic carbides (MCz), inorganic oxycarbides (MOxCz), inorganic carbonitrides (MNyCz), inorganic oxynitrides (MOxNy), and inorganic oxycarbonitrides (MOxNyCz), wherein M represents a metal atom; x represents an oxygen atom; y represents the number of nitrogen atoms; and z represents the number of carbon atoms.

M is preferably a metal element such as Si, Al, or Ti.

Further, for example, compounds to which, for example, metals or semiconductors have been added, compounds which have been replaced with, for example, metals or semiconductors, or a mixture of two or more of them may also be used.

For the composition of the gas barrier layer 13, for example, the component ratio and properties can be confirmed, for example, by an analytical method in which, for example, ion etching is carried out in a depth direction and the elementary analysis of the silicon oxide film is carried out with a surface analyzer such as a photoelectron spectrophotometer, an X-ray photoelectron spectroscopic apparatus (XPS), and a secondary ion mass analyzer (SIMS).

Production Process of Gas Barrier Layer

The production process of the gas barrier layer 13 is not particularly limited. Preferably, however, the gas barrier layer 13 is produced by applying, for example, vacuum vapor deposition, sputtering or ion plating, or CVD methods such as Cat-CVD, plasma CVD, or atmospheric plasma CVD. The method may be selected by taking into consideration, for example, the type of the film forming material, easiness of film formation, and process efficiency.

For example, the vapor deposition is a method in which a material contained in a crucible is heated by electric resistance heating, high frequency induction heating, or heating using beams such as electron beams or ion beams and evaporated to deposit the vapor onto a flexible base material (for example, a plastic film) to form a thin film. In this case, the heating temperature and heating method may vary depending, for example, upon material and purpose, and reactive vapor deposition, which causes an oxidation reaction or the like, may also be used.

The plasma CVD is a kind of chemical vapor deposition method. In this method, a starting material is gasified and supplied into a part where plasma discharge takes place. The gases within the system collide with each other and consequently are mutually activated and become radicals. As a result, a low-temperature reaction, which does not take place by mere thermal excitation, becomes possible. The substrate is heated from its backside by a heater, and a film is formed by a reaction during discharge between the electrodes. Plasma CVD methods are classified according to frequency used in plasma generation into HF (several tens of kHz to several hundreds of kHz), RF (13.56 MHz), and microwaves (2.45 GHz).

When microwaves are used, the methods are roughly classified into a method in which a reactive gas is excited and a film is formed during afterglow, and ECR plasma CVD in which microwaves are introduced into a magnetic field (875 gausses) satisfying ECR conditions. Further, the methods may be classified according to a plasma generation method into a capacitance coupling method (a parallel flat plate type) and an inductive coupling method (a coil method).

The ion plating method is a combined technique of vacuum vapor deposition and plasma in which, in principle, gas plasma is utilized for conversion of a part of evaporated particles into ions or excited particles for activation to form a thin film. Accordingly, reactive ion plating, in which a reactive gas plasma is utilized for bonding to evaporated particles to synthesize a compound film, is very effective. The operation is carried out in plasma, and, thus, a requirement for stable plasma generation should first satisfied. For this reason, in many cases, low-temperature plasma using weakly ionized plasma in a low gas pressure region is used. Ion plating methods are roughly classified according to means for causing discharge into a direct current excitation type and a high-frequency excitation type. In addition, in some cases, a hollow cathode or an ion beam is used in an evaporation mechanism.

<Substrate for Display>

The substrate for a display according to the present invention, comprises the film with a transparent electroconductive membrane according to the present invention.

The substrate for a display according to the present invention includes a substrate for a display as shown in FIG. 3 in which a transparent electrode layer 11, optionally an auxiliary electrode layer, and optionally other layers are provided on the surface of the cured resin layer, the gas barrier layer 13 or the smoothing layer 14.

<Display>

The display according to the present invention, comprises the substrate for a display according to the present invention.

When the film with a transparent electroconductive membrane according to the present invention is used as a substrate for a display, layers necessary in each display system may be stacked on any one of obverse and reverse surfaces of the film with a transparent electroconductive membrane. In some cases, these layers may be stacked between the base material film and the gas barrier layer. Accordingly, the film with a transparent electroconductive membrane according to the present invention include a film in which layers for imparting a display function is interposed between the base material film and the thin-film layer.

The requirement for the display is that the display comprises the above display substrate. The display substrate is suitable for small-depth thin displays, for example, plasma display panels (PDPs), liquid crystal displays (LCDs), organic or inorganic electroluminescent displays (ELDs), and field emission displays (FEDs).

<Liquid Crystal Display Device>

The liquid crystal display device according to the present invention, comprises the substrate for a display according to the present invention. The liquid crystal display device (LCD) generally comprises two glass substrates, a transparent electrode disposed on the inner side of each of the two glass substrates, other elements such as an aligning layer provided on the electrodes, and a liquid crystal held between the two substrates, the periphery of the assembly having been sealed. The liquid crystal display device further comprises a color filter for providing color display. The film with a transparent electroconductive membrane according to the present invention may be applied on the outer side of the glass substrate in the liquid crystal display. Alternatively, the film with a transparent electroconductive membrane according to the present invention may be used instead of the glass substrate. In particular, when both the two glass substrates are replaced with the film with a transparent electroconductive membrane according to the present invention, the whole display can be rendered flexible.

Some liquid crystals are optically anisotropic, and, in this case, an epoxy resin cannot be used. However, the epoxy resin can be rendered applicable by not using a polarizing plate or changing the position of the liquid crystal layer. For example, plastic liquid crystals and polymer dispersed liquid crystals may be mentioned as this type of liquid crystal.

Plastic liquid crystals are usable for displays for use in mobile devices such as personal digital assistants, communication devices (for example, cellular phones), notebook computers, and amusement devices (for example, small-sized computer gaming machines), can realize high performance, for example, lightweight, thin shape, durability, high display capacity, and good visibility, and can meet a low power consumption requirement related to a reduction in battery capacity. For example, a weight of about one-third of the conventional glass substrate, a thinness of about a half of the conventional glass substrate, durability of about ten times the durability of glass, and visibility on such a high level that a double image is not substantially observed even in a reflection mode can also be realized.

Polymer dispersed liquid crystals are aligned by applying an electric field to small particles of liquid crystals dispersed in a polymer and are used as an optical shutter. In the polymer dispersed liquid crystals, unlike TN (twisted nematic) liquid crystal, a scattering-nonscattering phenomenon is utilized. Therefore, in principle, a polarizing plate is unnecessary. The polymer dispersed liquid crystals are advantageous, for example, in that, the brightness is increased because of unnecessity of provision of the polarizing plate, the image display operation speed is high, the step of pouring a liquid crystal is unnecessary, the control of cell gap is easy, and rubbing is unnecessary. Further, the polymer dispersed liquid crystals can also be applied to projection-type liquid crystal display devices.

<Organic EL Element>

The organic EL element according to the present invention, comprises the above substrate for a display.

A display comprising this organic EL element comprises two substrates, a transparent electrode provided on the inner side of each of the two substrates, and an organic EL element layer comprising, for example, a composite layer formed of a laminate of layers having functions of (a) an injection function, (b) a transport function, and (c) a luminescence function and disposed between the two substrates, the periphery of the assembly having been sealed. When an EL display is constructed, for example, a layer construction of substrate for thin display according to the present invention (including a patterned transparent electroconductive layer/auxiliary electrode layer)/hole injection layer/hole transport layer/luminescent layer/electron injection layer/cathode/sealing layer may be adopted. The layer construction is not particularly limited, and a wide variety of layer constructions may be adopted. Specific examples thereof include anode/luminescent layer/cathode, anode/hole injection layer/luminescent layer/cathode, anode/luminescent layer/electron injection layer/cathode, anode/hole injection layer/luminescent layer/electron injection layer/cathode, and anode/hole injection layer/hole transport layer/luminescent layer/electron transport layer/electron injection layer/cathode. The construction may further comprise a color filter for color display or other multiple means (layers). As with the liquid crystal display, the film with a transparent electroconductive membrane according to the present invention may be applied to the outer side of the glass substrate. Alternatively, the film with a transparent electroconductive membrane according to the present invention may be used instead of the glass substrate. In particular, when both the two glass substrates are replaced with the film with a transparent electroconductive membrane according to the present invention, the whole display can be rendered flexible. In particular, the organic EL element is chemically unstable because fluorescence is utilized. Further, the moisture resistance of the organic EL element is very low. Accordingly, a high level of water vapor barrier properties as a product is desired. Also from the viewpoint of ensuring water vapor barrier properties of the laminated structure of the gas barrier film, preferably, the base material film for the gas barrier film has a loaded deflection temperature of 150° C. or above, preferably 160° C. or above

<Solar Battery>

The film with a transparent electroconductive membrane according to the present invention is also suitable for use in solar batteries where the moisture resistance is required and the protection of the contents is necessary, for example, organic solar batteries and dye-sensitized solar batteries.

Second Invention

<Film with a Transparent Electroconductive Membrane>

The film with a transparent electroconductive membrane according to the second invention, comprises a transparent base material and a transparent electroconductive membrane, the film having an extinction coefficient against light with a wavelength of 550 nm of not more than 0.05 and a yellowness (YI) of 0.5 to 3.0.

The yellowness (YI) is specified by JIS K 7105. The extinction coefficient is measured with an ellipsometer (model number: UVISEL, manufactured by JOBIN YVON) at a wavelength of λ=550 nm.

The extinction coefficient will be described.

When a material absorbs light, the intensity I of light decreases according to a relational expression of I=I0e−αx. In this case, α represents extinction per unit length and is called “absorption coefficient.”

Light absorption (optical density) at the time when light passed through a material having a certain thickness is defined by OD=−log(I/I0). A comparison of two equations shows that, when the thickness of the material is L, OD and α are combined by an equation of α=2.303×OD/L. As is apparent from the definition, α represents absorption per unit length. On the other hand, when interaction between light and the material is handled theoretically, the absorption of light per unit vibration of the electromagnetic field is used as a reference. Accordingly, an extinction coefficient k is defined as quantity for defining the absorption of light by the material. There is a relation of k=α×λ/4π between the absorption coefficient α and the extinction coefficient k, wherein λ represents the wavelength of incident light in vacuum. Accordingly, for a sample of which the optical density is constant in a certain wavelength range, the absorption coefficient does not depend upon the wavelength while the extinction coefficient increases toward a shorter wavelength side. Specifically, in the present invention, values of measurement with an ellipsometer (model number: UVISEL, manufactured by JOBIN YVON) at wavelength λ=550 nm were used.

The film with a transparent electroconductive membrane, comprising a transparent base material and a transparent electroconductive membrane, according to the present invention is not limited to only (i) a film with a transparent electroconductive membrane, comprising a single layer of a transparent base material and a single layer of a transparent electroconductive membrane, and includes, for example, (ii) a film with a transparent electroconductive membrane, comprising a single layer or a plurality of layers of a transparent base material and a single or a plurality of layers of a transparent electroconductive membrane, wherein any one of or both the transparent base material and the transparent electroconductive membrane are provided plurally, and (iii) a film with a transparent electroconductive membrane having the same construction as the film (i) or (ii) except that a layer or a material other than the transparent base material and the transparent electroconductive membrane is further formed singly or plurally. Specific examples of preferred layers or materials other than the transparent base material and the transparent electroconductive membrane include, for example, a gas barrier layer and a smoothing layer which will be described later.

Further, it should be noted that, in the film with a transparent electroconductive membrane according to the present invention, the transparent electroconductive membrane is not always evenly formed on substantially the whole surface of the transparent base material. Accordingly, the film with a transparent electroconductive membrane according to the present invention include, for example, one in which a transparent electroconductive membrane is partially formed on the transparent base material, for example, one in which the transparent electroconductive membrane is formed in a pattern form on the transparent base material.

Preferably, the total light transmittance of the film with a transparent electroconductive membrane according to the present invention is not less than 75%, particularly preferably not less than 80%. The total light transmittance is as specified in according to JIS K 7361-1.

FIGS. 1 and 2 show particularly preferred embodiments of the film with a transparent electroconductive membrane according to the present invention. The film with a transparent electroconductive membrane according to the present invention shown in FIG. 1 has a layer construction of “transparent base material 10/transparent electroconductive membrane 11” as viewed from the lowermost layer. The film 1 with a transparent electroconductive membrane according to the present invention shown in FIG. 2 has a layer construction of “second smoothing layer 14B/second gas barrier layer 13B/transparent base material 10/first gas barrier layer 13A/first smoothing layer 14A/transparent electroconductive membrane 11” as viewed from the lowermost layer. The substrate for a display according to the present invention shown in FIG. 3 has a layer construction of “gas barrier layer 13/transparent base material 10/gas barrier layer 13/smoothing layer 14/gas barrier layer 13/transparent electroconductive layer 11/auxiliary electrode layer 15”. In FIG. 2, the first gas barrier layers are formed so as to hold the first smoothing layer therebetween, and the second gas barrier layers are formed so as to hold the second smoothing layer therebetween. Alternatively, only one first gas barrier layer and only one second gas barrier layer may be formed.

Each layer constituting the film 1 with a transparent electroconductive membrane according to the present invention shown in FIG. 2 will be described.

(1) Transparent Electroconductive Membrane

A transparent electroconductive thin film 11 may be a coating layer composed mainly of an inorganic oxide formed by coating a hydrolyzate of a metal alkoxide or the like or by coating transparent electroconductive particles and a hydrolyzate of a metal alkoxide or the like, or may be a thin film formed by a vacuum film forming method such as resistance heating vapor deposition, induction heating vapor deposition, EB vapor deposition, sputtering, ion plating, thermal CVD, or plasma CVD. The EB vapor deposition, sputtering, and ion plating using an apparatus construction, which can provide a low-resistance and surface treatable transparent electroconductive membrane, are particularly preferred. The material for the transparent electroconductive membrane is properly selected from indium-tin-base oxide (ITO), indium-tin-zinc-base oxide (ITZO), ZnO₂-based materials, CdO-based materials, SnO₂-based materials and the like. Among others, indium-tin-base oxide (ITO) is preferred from the viewpoint of excellent transparency and electroconductivity. In particular, the content of tin in the indium-tin-base oxide (ITO) is preferably 5 to 15% by mole. The thickness of the indium-tin-base oxide (ITO) thin film is preferably 10 nm to 1000 nm, more preferably 60 nm to 450 nm. When the thickness is less than 10 nm, the electroconductivity of the transparent electroconductive membrane used as the transparent electrode layer is unsatisfactory. On the other hand, when the thickness is not less than 200 nm, disadvantageously, the transparency and flex resistance are deteriorated. The indium-tin-base oxide (ITO) thin film may be noncrystalline or crystalline or alternatively may have an intermediate between noncrystalline and crystalline properties (a mixed type). In the formation of the thin film according to the present invention, the mixed type is better.

The transparent electroconductive membrane according to the present invention can have desired electrical resistivity and can be prepared so as to have an electrical resistivity in the range of 3.0×10⁻⁴ to 10³Ω·cm.

In the formation of the preferred transparent electroconductive membrane, preferably, instead of a method in which a transparent electroconductive membrane having a finally necessary thickness is formed in a single continuous step, a method is adopted in which the transparent electroconductive membrane is formed through a plurality of divided steps, while accumulating the transparent electroconductive membrane formed in each unit transparent electroconductive membrane formation, in which, after the formation of each transparent electroconductive membrane, treatment with an oxidizing gas is carried out.

In the present invention, a method is particularly preferably adopted in which a transparent electroconductive membrane is formed in a thickness of 0.3 to 10 nm per unit transparent electroconductive membrane formation, and, every time when the 0.3 to 10 nm-thick transparent electroconductive membrane is formed, the step of subjecting the assembly to any one of plasma treatment, ion bombardment treatment, glow discharge treatment, arc discharge treatment, and spray treatment is carried out a plurality of times in an oxidizing gas, while accumulating the transparent electroconductive membrane formed in each unit transparent electroconductive membrane formation.

When the thickness of the transparent electroconductive membrane per unit transparent electroconductive membrane formation is less than 0.3 nm, disadvantageously, the productivity is low and, further, the electroconductivity is lowered. On the other hand, when the thickness of the transparent electroconductive membrane per unit transparent electroconductive membrane formation exceeds 10 nm, the effect of high transparency is sometimes less likely to be attained. The thickness of the transparent electroconductive membrane per unit transparent electroconductive membrane formation is particularly preferably 0.5 to 5 nm. In this connection, it should be noted that, in each unit transparent electroconductive membrane formation, a transparent electroconductive membrane having an identical thickness may be formed, or alternatively a transparent electroconductive membrane having a different thickness may be formed.

N₂O, NO₂, N₂O₄, N₂O₅, ozone, oxygen molecules, oxygen atoms, oxygen radicals, and oxygen ions are preferred as the oxidizing gas used for the treatment. Preferably, the oxidizing gas is diluted with an inert gas, for example, argon, helium, or nitrogen. Further, the proportion of the oxidizing gas to the inert gas 1 is particularly preferably 0.01 to 10. Among the above oxidizing gases, a combination of an oxygen molecule with argon is particularly preferred. In the present invention, the use of a mixed gas composed of two or more of the above oxidizing gases may also be used.

Among the plasma treatment, ion bombardment treatment, glow discharge treatment, arc discharge treatment, and spray treatment, the plasma treatment, ion bombardment treatment, and glow discharge treatment are particularly preferred from the viewpoints of homogeneity of the surface treatment and the persistence of the effect.

When the treatment is carried out a plurality of times, for each treatment, the type of the oxidizing gas and the details of the treatment may be identical or different.

In the present invention, when a vacuum film formation method is adopted, the apparatus for use in the transparent electroconductive thin film formation is preferably an apparatus which can alternately perform thin film formation and annealing, for example, an apparatus comprising a plurality of coating parts and a drum-type apparatus.

(2) Transparent Base Material

A synthetic resin film which has hitherto been used as a material for a display substrate may be used as a transparent base material 10 in the film 1 with a transparent electroconductive membrane according to the present invention. In the present invention, a synthetic resin film having a total light transmittance of 60 to 99%, preferably 80 to 95%, is preferred. The thickness of the base material may be properly determined depending, for example, upon specific applications of the film with a transparent electroconductive membrane. The thickness of the base material, however, is preferably 12 to 300 μm, particularly preferably 50 to 200 μm. The transparency is defined by the total light transmittance. In the film 1 with a transparent electroconductive membrane according to the present invention, conventional resin layers called an easy-adhesion layer, an adhesion accelerating layer, a primer layer, an undercoating layer, or an anchor coating layer may be formed on the transparent base material 10 in its first gas barrier layer 13A or second gas barrier layer 13B forming surface, from the viewpoint of improving the wettability and adhesion between the transparent base material 10 and the gas barrier layer.

Specific examples of preferred resin films usable as the base material film include films of crystalline resins, for example, thermoplastic resins, such as polyamides, polyacetals, polybutylene terephthalates, polyethylene terephthalates, polyethylene naphthalates, or syndiotactic polystyrenes, and heat curable resins such as polyphenylene sulfides, polyether ether ketones, liquid crystal polymers, fluororesins, or polyether nitrites. Examples of synthetic resins, which are more preferred resins, as materials for constituting the base material films include noncrystalline resins, for example, thermoplastic resins such as polycarbonates, modified polyphenylene ethers, polycyclohexenes, or polynorbornene resins, and heat curable resins such as polysulfones, polyethersulfones, polyarylates, polyamide imides, polyether imides, or thermoplastic polyimides. Among them, polycarbonates are particularly preferred because, by virtue of their low water absorption, base material films formed by the polycarbonate have a low coefficient of moisture expansion.

The loaded deflection temperature is a more practical index for thermal properties required of the base material film, particularly behavior against external force and is specified in JIS K 7191. Examples of loaded deflection temperatures for respective resins are 155° C. for polyethylene naphthalate resin (PEN), 160° C. for polycarbonate resin, 175° C. for polyarylate resin, 210° C. for polyethersulfone resin, 150° C. for cycloolefin polymer (manufactured by Zeon Corporation, tradename; “ZEONOR”), and 155° C. for norbornene resin (manufactured by JSR Corporation, tradename; “ARTON”).

When the film constituting a base material film 10 layer is a polyester, a linear saturated polyester synthesized from an aromatic dibasic acid or its ester forming derivative and a diol or its ester forming derivative is preferred as the polyester. Some conventional polyesters have a loaded deflection temperature of 150° C. or below. The polyester as the base material film 11 layer referred to herein is a polyester having a loaded deflection temperature of 150° C. or above. Specific examples of polyesters include polyethylene terephthalate, polyethylene isophthalate, polyethylene isophthalate, polybutylene terephthalate, poly(1,4-cyclohexylene dimethylene terephthalate), and polyethylene-2,6-naphthalate. The polyester may also be a copolymer of the above polymers or a blend of the above polymers with a minor proportion of other resins. Among these polyesters, polyethylene terephthalate and polyethylene-2,6-naphthalate are preferred because of a good balance between kinetic properties, optical properties and the like. In particular, polyethylene-2,6-naphthalate is superior to polyethylene terephthalate, for example, in large mechanical strength, small thermal shrinkage, small amount of oligomer production upon heating. Further, polyethylene-2,6-naphthalate has high chemical resistance. Accordingly, also in a method including an etching step, for example, when a pattern layer is formed by etching using a resist followed by gas barrier membrane formation, advantageously, for example, the surface of the polyethylene naphthalate resin film is not significantly deteriorated and, thus, a gas barrier membrane and the like can be stably formed to impart excellent gas barrier properties.

The polyester may be a homopolymer or a copolymer using a third comonomer component, preferably a homopolymer. When the polyester is polyethylene terephthalate, an isophthalic acid-copolymerized polyethylene terephthalate is best suited as the copolymer. The content of isophthalic acid in the isophthalic acid-copolymerized polyethylene terephthalate is preferably not more than 5% by mol. In the polyester, a comonomer component other than isophthalic acid or a comonomer alcohol component may be copolymerized in such an amount that does not sacrifice the properties of the polyester, for example, in an amount of not more than 3% by mole based on the whole acid component or the whole alcohol component. Examples of such comonomer acid components include aromatic dicarboxylic acids such as phthalic acid and 2,6-naphthalenedicarboxylic acid, and aliphatic dicarboxylic acids such as adipic acid, azelaic acid, sebacic acid, and 1,10-decanedicarboxylic acid. Examples of alcohol components include aliphatic diols such as 1,4-butanediol, 1,6-hexanediol, and neopentyl glycol, and alicyclic diol such as 1,4-cyclohexane dimethanol. They may be used solely or in a combination of two or more.

When the polyester is polyethylene-2,6-naphthalene dicarboxylate, naphthalenedicarboxylic acid is used as a main dicarboxylic acid component and ethylene glycol is used as a main glycol component. Naphthalenedicarboxylic acids include, for example, 2,6-naphthalenedicarboxylic acid, 2,7-naphthalenedicarboxylic acid, and 1,5-naphthalenedicarboxylic acid. Among them, 2,6-naphthalenedicarboxylic acid is preferred. The term “main” as used herein means at least 90% by mole, preferably at least 95% by mole, of the total repeating units in the constituents of the polymer as the component of the film according to the present invention.

(3) Smoothing Layer

In the film 1 with a transparent electroconductive membrane according to the present invention, if necessary, a first smoothing layer 14A and a second smoothing layer 14B (collectively referred to as “smoothing layer 14”) may be provided on the surface of the gas barrier layer 13. A sol-gel material, an ionizing radiation curable resin, a heat curable resin, a photoresist material may also be used for the formation of the smoothing layer 14 so far as these materials are coated for flattening the surface of the assembly. Preferably, however, the smoothing layer 14 is formed from a material which can impart a gas barrier function and has excellent coatability. The use of the ionizing radiation curable resin is preferred from the viewpoint of improving the coatability. In this case, the smoothing layer may be formed by coating a resin, which, upon exposure to ultraviolet light (UV) or electron beams (EB), induces a crosslinking polymerization reaction for conversion to a three-dimensional polymer structure, that is, an ionizing radiation curable resin into which a reactive prepolymer, an oligomer, and/or a monomer containing a polymerizable unsaturated bond or an epoxy group in its molecule has been properly mixed, or a liquid composition produced by optionally mixing a thermoplastic resin such as a urethane, polyester, acryl, butyral, or vinyl resin into the ionizing radiation curable resin in consideration of coatability and the like and bringing the resin to a liquid, by a well-known coating method such as roll coating, Mayer bar coating, or gravure coating and drying and curing the coating.

The thickness of the smoothing layer may be properly determined depending, for example, upon specific applications of the film with a transparent electroconductive membrane and is preferably 0.05 to 10 μm, particularly preferably 0.1 to 5 μm.

Ionizing Radiation Curable Resin

Suitable specific ionizing radiation curable resins are those containing an acrylate-type functional group, that is, those having an acryl skeleton or epoxy skeleton. When the hardness, heat resistance, solvent resistance, and scratch resistance of the coating film are taken into consideration, a structure having a high crosslinking density is preferred. In this case, preferred are bi- or higher functional acrylate monomer, for example, ethylene glycol di(meth)acrylate, 1,6-hexanediol diacrylate, trimethylolpropane tri(meth)acrylate, pentaerythritol tri(meth)acrylate, dipentaerythritol penta(meth)acrylate, and dipentaerythritol hexa(meth)acrylate. In the above description, “(meth)acrylate” means both acrylate and methacrylate.

The ionizing radiation curable resin is satisfactorily cured upon exposure to electron beams. When the application of ultraviolet light for curing is contemplated, photopolymerization initiators, for example, acetophenones, benzophenones, thioxanthones, benzoins, benzoin methyl ether, Michler's benzoyl benzoate, Michler's ketone, diphenyl sulfide, dibenzyl disulfide, diethyl oxide, triphenyl bisimidazole, and isopropyl-N,N-dimethylaminobenzoate, and photosensitizers, for example, n-butylamine, triethylamine, and poly-n-butylphosphine are preferably used solely or as a mixture of two or more. The addition amount of the photopolymerization initiator or photosensitizer is generally about 0.1 to 10 parts by weight based on 100 parts by weight of the ionizing radiation curable resin. If necessary, various inorganic or organic additives such as silane compounds other than the above compounds, solvents, curing catalysts, wetting improvers, plasticizers, antifoaming agents, and thickeners may be added to the coating material composition.

The coverage of the coating material composition is suitably approximately 0.5 to 15 g/m² on a solid basis. Light sources such as ultrahigh-pressure mercury lamps, high-pressure mercury lamps, low-pressure mercury lamps, carbon arc lamps, backlight fluorescent lamps, and metal halide lamps are usable as the ultraviolet light source for curing. The wavelength of the ultraviolet light may be in the range of 190 to 380 nm. Various electron beam accelerators, for example, Cockcroft-Walton accelerators, van de Graaff accelerators, resonance transformers, insulated core transformers, and linear, dynamitron and high-frequency electron accelerators are usable as the electron beam source.

Sol-Gel Method

For example, in order to provide good adhesion between the smoothing layer and the barrier layer, a sol-gel material using a sol-gel method, which can form coating films of an identical material, is preferred as the material for the smoothing layer in the present invention.

The sol-gel method refers to a method for coating a coating material composition, or a coating film, comprising, as raw materials, at least a silane coupling agent containing an organic functional group and a hydrolyzable group and a crosslinkable compound containing an organic functional group reactive with the organic functional group possessed by the silane coupling agent. Aminoalkyldialkoxysilanes or aminoalkyltrialkoxysilanes represented by general formula (a) disclosed, for example, in Japanese Patent Laid-Open No. 207130/2001 are preferred as the silane coupling agent containing an organic functional group and a hydrolyzable group (hereinafter often referred to simply as “silane coupling agent”).

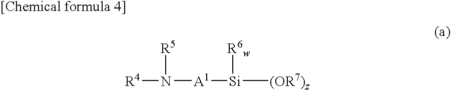

wherein A¹ represents an alkylene group; R⁴ represents a hydrogen atom, a lower alkyl group, or a group represented by general formula (b); R⁵ represents a hydrogen atom or a lower alkyl group; R⁶ represents an alkyl group having 1 to 4 carbon atoms, an aryl group, or an unsaturated aliphatic residue, and, when a plurality of R⁶s are present in its molecule, they may be the same or different; R⁷ represents a hydrogen atom, an alkyl group having 1 to 4 carbon atoms, or an acyl group, preferably a hydrogen atom, an alkyl group having 1 to 3 carbon atoms, or an acyl group, and, when a plurality of R⁷s are present in its molecule, they may be the same or different; and w is 0 (zero), 1, or 2 and z is an integer of 1 to 3, provided that w+z=3; and

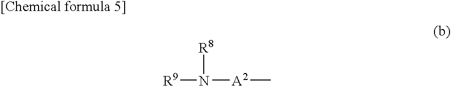

wherein A² represents a direct bond or an alkylene group; R⁸ and R⁹ each independently represent a hydrogen atom or a lower alkyl group; and at least one of R⁴, R⁵, R⁸, and R⁹ represents a hydrogen electron.

Specific examples of aminoalkyldialkoxysilanes or aminoalkyltrialkoxysilanes represented by formula (a) include N-β(aminoethyl)γ-aminopropyltrimethoxysilane, N-β(aminoethyl)γ-aminopropyltriethoxysilane, N-β(aminoethyl)γ-aminopropyltriisopropoxysilane, N-β(aminoethyl)γ-aminopropyltributoxysilane, N-β(aminoethyl)γ-aminopropylmethyldimethoxysilane, N-β(aminoethyl)γ-aminopropylmethyldiethoxysilane, N-β(aminoethyl)γ-aminopropylmethyldiisopropoxysilane, N-β(aminoethyl)γ-aminopropylmethyldibutoxysilane, N-β(aminoethyl)γ-aminopropylethyldimethoxysilane, N-β(aminoethyl)γ-aminopropylethyldiethoxysilane, N-β(aminoethyl)γ-aminopropylethyldiisopropoxysilane, N-β(aminoethyl)γ-aminopropylethyldibutoxysilane, γ-aminopropyltrimethoxysilane, γ-aminopropyltriethoxysilane, γ-aminopropyltriisopropoxysilane, γ-aminopropyltributoxysilane, γ-aminopropylmethyldimethoxysilane, γ-aminopropylmethyldiethoxysilane, γ-aminopropylmethyldiisopropoxysilane, γ-aminopropylmethyldibutoxysilane, γ-aminopropylethyldimethoxysilane, γ-aminopropylethyldiethoxysilane, γ-aminopropylethyldiisopropoxysilane, γ-aminopropylethyldibutoxysilane, and γ-aminopropyltriacetoxysilane. They may be used solely or in a combination of two or more.

The “crosslinkable compound containing an organic functional group reactive with the organic functional group possessed by the silane coupling agent” (hereinafter referred to simply as “crosslinkable compound”) is a crosslinkable compound containing a functional group reactive with an amino group, for example, a glycidyl group, a carboxyl group, an isocyanate group, or an oxazoline group, and specific examples thereof include diglycidyl ethers such as ethylene glycol diglycidyl ether, diethylene glycol diglycidyl ether, triethylene glycol diglycidyl ether, tetraethylene glycol diglycidyl ether, nenoethylene glycol diglycidyl ether, propylene glycol diglycidyl ether, dipropylene glycol diglycidyl ether, tripropylene glycol diglycidyl ether, 1,6-hexane diol diglycidyl ether, neopentyl glycol diglycidyl ether, adipic acid diglycidyl ether, o-phthalic acid diglycidyl ether, and glycerol diglycidyl ether; triglycidyl ethers such as glycerol triglycidyl ether, digylcerol triglycidyl ether, triglycidyl tris(2-hydroxyethyl)isocyanurate, and trimethylolpropane triglycidyl ether; tetraglycidyl ethers such as pentaerythritol tetraglycidyl ether; other polyglycidyl ethers or polymers containing a glycidyl group as a functional group; dicarboxylic acids such as tartaric acid and adipic acid; carboxyl group-containing polymers such as polyacrylic acid; isocyanates such as hexamethylene diisocyanate and xylylene diisocyanate; oxazoline-containing polymers; and alicyclic epoxidized compounds. They may be used solely or in a combination of two or more. Compounds containing two or more glycidyl groups are preferred from the viewpoint of reactivity.

The amount of the crosslinkable compound used is preferably 0.1 to 300% (by mass; the same shall apply hereinafter), more preferably 1 to 200%, based on the silane coupling agent. When the amount of the crosslinkable compound used is less than 0.1%, the flexibility of the coating film is unsatisfactory. On the other hand, when the amount of the crosslinkable compound used is more than 300%, there is a possibility that the gas barrier properties are deteriorated. The silane coupling agent and the crosslinkable compound are stirred optionally while heating to prepare a coating material composition.

When the coating material composition comprising a silane coupling agent and a crosslinkable compound as raw material is coated on the thin-film layer 4 followed by drying, the hydrolysis and condensation of the silane coupling agent and crosslinking by the crosslinkable compound proceed to form a coating film of polysiloxane having a crosslinked structure.

The above composition may further contain a silane compound which contains a hydrolyzable group and is free from an organic functional group such as an amino group. Specific examples of such silane compounds include tetramethoxysilane, tetraethoxysilane, tetraisopropoxysilane, tetrabutoxysilane, methyltrimethoxysilane, methyltriethoxysilane, methyltriisopropoxysilane, methyltributoxysilane, ethyltrimethoxysilane, ethyltriethoxysilane, ethyltriisopropoxysilane, ethyltributoxysilane, dimethyldimethoxysilane, dimethyldiethoxysilane, dimethyldiisopropoxysilane, dimethyldibutoxysilane, diethyldimethoxysilane, diethyldiethoxysilane, diethyldiisopropoxysilane, diethyldibutoxysilane, vinyltrimethoxysilane, vinyltriethoxysilane, γ-glycidopropyltrimethoxysilane, γ-glycidopropyltriethoxysilane, γ-methacryloxypropyltrimethoxysilane, γ-chloropropyltrimethoxysilane, and γ-mercaptopropyltrimethoxysilane. They may be used solely or in a combination of two or more.

When the silane compound, which contains a hydrolyzable group and is free from an organic functional group such as an amino group, is contained, the cohydrolysis condensation of the silane compound with a silane coupling agent, which contains a hydrolyzable group and an organic functional group such as an amino group, and crosslinking by the crosslinkable compound proceed to form a coating film of polysiloxane having a crosslinked structure.

The coating material composition may further contain a silane coupling agent containing an organic functional group such as an amino group and a hydrolyzable group and/or a (co)hydrolysis condensate of a silane compound, which contains a hydrolyzable group and is free from an organic functional group such as an amino group. If necessary, various inorganic or organic additives such as silane compounds other than the above compounds, solvents, curing catalysts, wetting improvers, plasticizers, antifoaming agents, and thickeners may be added to the coating material composition.

Cardo Polymer

The material for the smoothing layer preferably contains a cardo polymer. The cardo polymer is a polymer having the following cardo structure and is synthesized from a monomer having a cardo structure and other polymerizable monomer. For example, cardo polyester polymers, a cardo acryl polymers, and cardo epoxy polymers can be applied. Among them, cardo epoxy polymers are preferred. The smoothing layer may contain the cardo polymer as a main component.

If necessary, additives such as plasticizers, fillers, antistatic agents, lubricants, antiblocking agents, antioxidants, ultraviolet absorbers, and photostabilizers, and, further, modifying resins may be added to the smoothing layer.

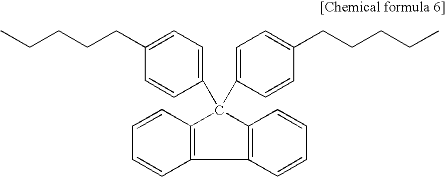

The cardo polymer has a unique structure called a cardo structure in a main chain skeleton of a polymer. The cardo structure contains a number of aromatic rings. Due to its steric hindrance, a fluorene skeleton moiety and the main chain direction are in a twist positional relationship. Accordingly, it is considered that the carbon atom part located in the center of the polymer can change a bond angle relatively freely and, thus, the cardo polymer is strong and tough and, despite such properties, does not become brittle even at low temperatures and further has high hardness and scratch resistance.

A layer containing the cardo polymer has good leveling properties and can fill and cover defects and, after drying, has higher surface smoothness. Further, the layer has good affinity and wetting properties for the inorganic compound (the gas barrier layer 13A according to the present invention) and thus can fill, cover and clog defects such as pores, concaves, and cracks. Accordingly, a very high smoothing function can be exhibited by synergistic effect of the affinity and the leveling properties, and smoothing, that is, surface Ra and Rmax can be significantly lowered.

Thus, when the surface smoothness is enhanced, gas is adsorbed on the surface of the material, is dissolved in the material, is diffused in the material, and is radiated toward the opposite side. Accordingly, the adsorption sites (surface area) of oxygen or water vapor can be reduced. Thus, the adsorption on the surface in the first stage can be significantly reduced, and the gas barrier properties can be significantly improved.

(4) Gas Barrier Layer

In the film 1 with a transparent electroconductive membrane according to the present invention, if necessary, gas barrier layers 13A and 13B (collectively referred to as “gas barrier layer 13”) may be provided on the surface of the cured resin layer 12. The material for the gas barrier layer 13 is not particularly limited so far as the material has gas barrier properties. Examples of such materials include metals such as aluminum, nickel, chromium, iron, cobalt, zinc, gold, silver, and copper; semiconductors such as silicon, germanium, and carbon; inorganic oxides such as silicon oxide, aluminum oxide, magnesium oxide, indium oxide, calcium oxide, zirconium oxide, titanium oxide, boron oxide, zinc oxide, cerium oxide, hafnium oxide, and barium oxide; nitrides such as silicon nitride, aluminum nitride, boron nitride, and magnesium nitride; carbides such as silicon carbide; and sulfides. Further, oxynitrides which are composites of two or more of the above materials, and, furthermore, carbon-containing compounds such as oxycarbides, inorganic carbonitrides, inorganic oxycarbonitrides and the like may also be applied.

Preferred are inorganic oxides (MOx) such as aluminum oxide, silicon oxide, magnesium oxide, calcium oxide, zirconium oxide, and titanium oxide, inorganic nitrides (MNy), inorganic carbides (MCz), inorganic oxycarbides (MOxCz), inorganic carbonitrides (MNyCz), inorganic oxynitrides (MOxNy), and inorganic oxycarbonitrides (MOxNyCz), wherein M represents a metal atom; x represents an oxygen atom; y represents the number of nitrogen atoms; and z represents the number of carbon atoms.

M is preferably a metal element such as Si, Al, or Ti.

Further, for example, compounds to which, for example, metals or semiconductors have been added, compounds which have been replaced with, for example, metals or semiconductors, or a mixture of two or more of them may also be used.

For the composition of the gas barrier layer 13, for example, the component ratio and properties can be confirmed, for example, by an analytical method in which, for example, ion etching is carried out in a depth direction and the elementary analysis of the silicon oxide film is carried out with a surface analyzer such as a photoelectron spectrophotometer, an X-ray photoelectron spectroscopic apparatus (XPS), and a secondary ion mass analyzer (SIMS).

Production Process of Gas Barrier Layer

The production process of the gas barrier layer 13 is not particularly limited. Preferably, however, the gas barrier layer 13 is produced by applying, for example, vacuum vapor deposition, sputtering or ion plating, or CVD methods such as Cat-CVD, plasma CVD, or atmospheric plasma CVD. The method may be selected by taking into consideration, for example, the type of the film forming material, easiness of film formation, and process efficiency.

For example, the vapor deposition is a method in which a material contained in a crucible is heated by electric resistance heating, high frequency induction heating, or heating using beams such as electron beams or ion beams and evaporated to deposit the vapor onto a flexible base material (for example, a plastic film) to form a thin film. In this case, the heating temperature and heating method may vary depending, for example, upon material and purpose, and reactive vapor deposition, which causes an oxidation reaction or the like, may also be used.

The plasma CVD is a kind of chemical vapor deposition method. In this method, a starting material is gasified and supplied into a part where plasma discharge takes place. The gases within the system collide with each other and consequently are mutually activated and become radicals. As a result, a low-temperature reaction, which does not take place by mere thermal excitation, becomes possible. The substrate is heated from its backside by a heater, and a film is formed by a reaction during discharge between the electrodes. Plasma CVD methods are classified according to frequency used in plasma generation into HF (several tens of kHz to several hundreds of kHz), RF (13.56 MHz), and microwaves (2.45 GHz).

When microwaves are used, the methods are roughly classified into a method in which a reactive gas is excited and a film is formed during afterglow, and ECR plasma CVD in which microwaves are introduced into a magnetic field (875 gausses) satisfying ECR conditions. Further, the methods may be classified according to a plasma generation method into a capacitance coupling method (a parallel flat plate type) and an inductive coupling method (a coil method).

The ion plating method is a combined technique of vacuum vapor deposition and plasma in which, in principle, gas plasma is utilized for conversion of a part of evaporated particles into ions or excited particles for activation to form a thin film. Accordingly, reactive ion plating, in which a reactive gas plasma is utilized for bonding to evaporated particles to synthesize a compound film, is very effective. The operation is carried out in plasma, and, thus, a requirement for stable plasma generation should first satisfied. For this reason, in many cases, low-temperature plasma using weakly ionized plasma in a low gas pressure region is used. Ion plating methods are roughly classified according to means for causing discharge into a direct current excitation type and a high-frequency excitation type. In addition, in some cases, a hollow cathode or an ion beam is used in an evaporation mechanism.

<Substrate for Display>

The substrate for a display according to the present invention, comprises the film with a transparent electroconductive membrane according to the present invention.

The substrate for a display according to the present invention includes a substrate for a display as shown in FIG. 3 in which a transparent electrode layer 11, optionally an auxiliary electrode layer 15, and optionally other layers are provided on the surface of the cured resin layer 12, the gas barrier layer 13 or the smoothing layer 14.

<Display>

The display according to the present invention, comprises the substrate for a display according to the present invention.

When the film with a transparent electroconductive membrane according to the present invention is used as a substrate for a display, layers necessary in each display system may be stacked on any one of obverse and reverse surfaces of the film with a transparent electroconductive membrane. In some cases, these layers may be stacked between the base material film and the gas barrier layer. Accordingly, the film with a transparent electroconductive membrane according to the present invention include a film in which layers for imparting a display function is interposed between the base material film and the thin-film layer.

The requirement for the display is that the display comprises the above display substrate. The display substrate is suitable for small-depth thin displays, for example, plasma display panels (PDPs), liquid crystal displays (LCDs), organic or inorganic electroluminescent displays (ELDs), and field emission displays (FEDs).

<Liquid Crystal Display Device>

The liquid crystal display device according to the present invention, comprises the substrate for a display according to the present invention. The liquid crystal display device (LCD) generally comprises two glass substrates, a transparent electrode disposed on the inner side of each of the two glass substrates, other elements such as an aligning layer provided on the electrodes, and a liquid crystal held between the two substrates, the periphery of the assembly having been sealed. The liquid crystal display device further comprises a color filter for providing color display. The film with a transparent electroconductive membrane according to the present invention may be applied on the outer side of the glass substrate in the liquid crystal display. Alternatively, the film with a transparent electroconductive membrane according to the present invention may be used instead of the glass substrate. In particular, when both the two glass substrates are replaced with the film with a transparent electroconductive membrane according to the present invention, the whole display can be rendered flexible.

Some liquid crystals are optically anisotropic, and, in this case, an epoxy resin cannot be used. However, the epoxy resin can be rendered applicable by not using a polarizing plate or changing the position of the liquid crystal layer. For example, plastic liquid crystals and polymer dispersed liquid crystals may be mentioned as this type of liquid crystal.

Plastic liquid crystals are usable for displays for use in mobile devices such as personal digital assistants, communication devices (for example, cellular phones), notebook computers, and amusement devices (for example, small-sized computer gaming machines), can realize high performance, for example, lightweight, thin shape, durability, high display capacity, and good visibility, and can meet a low power consumption requirement related to a reduction in battery capacity. For example, a weight of about one-third of the conventional glass substrate, a thinness of about a half of the conventional glass substrate, durability of about ten times the durability of glass, and visibility on such a high level that a double image is not substantially observed even in a reflection mode can also be realized.

Polymer dispersed liquid crystals are aligned by applying an electric field to small particles of liquid crystals dispersed in a polymer and are used as an optical shutter. In the polymer dispersed liquid crystals, unlike TN (twisted nematic) liquid crystal, a scattering-nonscattering phenomenon is utilized. Therefore, in principle, a polarizing plate is unnecessary. The polymer dispersed liquid crystals are advantageous, for example, in that, the brightness is increased because of unnecessity of provision of the polarizing plate, the image display operation speed is high, the step of pouring a liquid crystal is unnecessary, the control of cell gap is easy, and rubbing is unnecessary. Further, the polymer dispersed liquid crystals can also be applied to projection-type liquid crystal display devices.

<Organic EL Element>

The organic EL element according to the present invention, comprises the above substrate for a display.

A display comprising this organic EL element comprises two substrates, a transparent electrode provided on the inner side of each of the two substrates, and an organic EL element layer comprising, for example, a composite layer formed of a laminate of layers having functions of (a) an injection function, (b) a transport function, and (c) a luminescence function and disposed between the two substrates, the periphery of the assembly having been sealed. When an EL display is constructed, for example, a layer construction of substrate for thin display according to the present invention (including a patterned transparent electroconductive layer/auxiliary electrode layer)/hole injection layer/hole transport layer/luminescent layer/electron injection layer/cathode/sealing layer may be adopted. The layer construction is not particularly limited, and a wide variety of layer constructions may be adopted. Specific examples thereof include anode/luminescent layer/cathode, anode/hole injection layer/luminescent layer/cathode, anode/luminescent layer/electron injection layer/cathode, anode/hole injection layer/luminescent layer/electron injection layer/cathode, and anode/hole injection layer/hole transport layer/luminescent layer/electron transport layer/electron injection layer/cathode. The construction may further comprise a color filter for color display or other multiple means (layers). As with the liquid crystal display, the film with a transparent electroconductive membrane according to the present invention may be applied to the outer side of the glass substrate. Alternatively, the film with a transparent electroconductive membrane according to the present invention may be used instead of the glass substrate. In particular, when both the two glass substrates are replaced with the film with a transparent electroconductive membrane according to the present invention, the whole display can be rendered flexible. In particular, the organic EL element is chemically unstable because fluorescence is utilized. Further, the moisture resistance of the organic EL element is very low. Accordingly, a high level of water vapor barrier properties as a product is desired. Also from the viewpoint of ensuring water vapor barrier properties of the laminated structure of the gas barrier film, preferably, the base material film for the gas barrier film has a loaded deflection temperature of 150° C. or above, preferably 160° C. or above

<Solar Battery>

The film with a transparent electroconductive membrane according to the present invention is also suitable for use in solar batteries where the moisture resistance is required and the protection of the contents is necessary, for example, organic solar batteries and dye-sensitized solar batteries.

### EXAMPLES

### Example A

The first invention is further illustrated by the following Examples and Comparative Examples that are not intended as a limitation of the invention.

Materials and formation methods for individual layers used in the Examples and Comparative Examples will be summarized.

(1) Base Material:

“Polyethylene naphthalate” (manufactured by Teijin Ltd., Teonex Q65 (100 μm)) was used as a base material in the Examples.

(2) Smoothing Layer:

A sol-gel layer used as a smoothing layer was formed by spin coating a coating agent composed mainly of an aminoalkyltrialkoxysilane, drying the coating on a hot plate at 120° C. for two min and then in an oven at 160° C. for one hr to form a 1.2 μm-thick sol-gel layer (a flattening layer).

An UV cured resin layer used as a smoothing layer was formed by coating the following UV cured resin composition, drying the coating at 120° C. for two min, and then applying ultraviolet light (UV) with a high pressure mercury lamp to cure the coating by UV irradiation to form a 0.8 μm-thick cured resin layer.

| | |
|---|---|
| Pentaerythritoltriacrylate; manufactured by | 50 parts |
| Nippon Kayaku Co., Ltd. | |
| Photopolymerization initiator (Irgacure 184; | 2 parts |
| manufactured by Ciba-Geigy Limited) | |
| Solvent (toluene) | 50 parts |

A smoothing layer formed of a heat cured resin was formed by spin coating V-259-EH (manufactured by Nippon Steel Chemical Co., Ltd., tradename), drying the coating at 120° C. for two min, and further drying the coating by hot air at 160° C. for 60 min to form a 1 μm-thick smoothing layer.

(3) Gas Barrier Layer:

Gas barrier layers 13 of the Examples and the Comparative Examples were formed as follows.

A gas barrier layer of SiOx (x=1.5 to 2.0) was formed by placing the assembly in a film forming chamber in an ion plating apparatus and conducting vapor deposition using silicon dioxide as a vapor deposition material under the following film forming conditions to form a gas barrier layer having a silicon oxide thickness of 100 nm.

<Conditions for Film Formation>

Film forming pressure: 1.7×10⁻¹ Pa

Argon gas flow rate: 30 sccm

Oxygen gas flow rate: 10 sccm

Applied voltage: 11.0 kW

A gas barrier layer of SiON was formed by placing the assembly in a film forming chamber in a magnetron sputtering apparatus and conducting magnetron sputtering using silicon nitride as a target under the following film forming conditions to form a gas barrier layer having a silicon oxynitride thickness of 100 nm.

<Conditions for Film Formation>

Film forming pressure: 2.5×10⁻¹ Pa

Argon gas flow rate: 30 sccm

Oxygen gas flow rate: 5 sccm

RF power supply frequency: 13.56 MHz

Applied voltage: 1.2 kW

A gas barrier layer of SiOC was formed by placing the assembly in a film forming chamber in a plasma CVD apparatus and conducting plasma CVD using hexamethyldisiloxane (HMDSO) as a starting material gas under the following film forming conditions to form gas barrier layer having a silicon oxycarbide thickness of 100 nm.

<Conditions for Film Formation>

Film forming pressure: 10 Pa

Argon gas flow rate: 10 sccm

Oxygen gas flow rate: 30 sccm

RF power supply frequency: 13.56 MHz

Applied voltage: 1.8 kW

### Example A1

A 0.5 nm-thick ITO film was formed on a base material by magnetron sputtering using ITO as a target under conditions of electric power 2.0 kW and Ar gas 500 sccm and was held in vacuum for 15 sec. These two steps were repeated 300 times to form a 150 nm-thick ITO film. For the ITO film as the uppermost layer, the particle diameter of the crystalline secondary particles and the number of crystalline secondary particles were measured and were found to be 0.3 μm and 5 particles/μm², respectively. The half-width value in the maximum peak of the crystal phase was 4.15. In order to form a 15-μm line by photolithography, the ITO layer was patterned with an etching liquid. As a result, the residue of the ITO particles was not observed under an optical microscope, and good patterning could be realized.

### Example A2

A 15 nm-thick ITO film was formed on a base material by a resistance heating-type vacuum deposition method. ITO particles were used as a material for the vapor deposition. The heating temperature was 1500° C. Plasma treatment was then carried out using a DC power supply under conditions of electric power 1 kW, Ar 200 sccm, and oxygen 500 sccm for 15 sec. These two steps were repeated ten times to form a 150 nm-thick ITO film. For the ITO film as the uppermost layer, the particle diameter of the crystalline secondary particles and the number of crystalline secondary particles were measured and were found to be 0.8 μm and 15 particles/μm², respectively. The half-width value in the maximum peak of the crystal phase was 6.50. In order to form a 15-1 μm line by photolithography, the ITO layer was patterned with an etching liquid. As a result, the residue of the ITO particles was not observed under an optical microscope, and good patterning could be realized.

### Example A3

A 150 nm-thick ITO film was formed on a base material by ion plating using ITO particles as a material for the vapor deposition under conditions of electric power 7.0 kW, Ar gas 50 sccm, and substrate temperature 100° C.

For the ITO film as the uppermost layer, the particle diameter of the crystalline secondary particles and the number of crystalline secondary particles were measured and were found to be 0.5 μm and 30 particles/μm², respectively. The half-width value in the maximum peak of the crystal phase was 1.50. In order to form a 15-μm line by photolithography, the ITO layer was patterned with an etching liquid. As a result, the residue of the ITO particles was not observed under an optical microscope, and good patterning could be realized.

### Example A4

A gas barrier film with a transparent electroconductive membrane was formed by forming an assembly having a layer construction of base material film/gas barrier layer (SiON) as viewed from the lowermost layer under the above conditions and forming an ITO layer as the uppermost layer in the same manner as in Example A1. For the ITO layer as the uppermost layer, the particle diameter of the crystalline secondary particles and the number of crystalline secondary particles were measured and were found to be 0.3 μm and 5 particles/μm², respectively. The half-width value in the maximum peak of the crystal phase was 3.38. In order to form a 15-μm line by photolithography, the ITO layer was patterned with an etching liquid. As a result, the residue of the ITO particles was not observed under an optical microscope, and good patterning could be realized.

### Example A5

A gas barrier film with a transparent electroconductive membrane was formed by forming an assembly having a layer construction of base material film/gas barrier layer (SiOC) as viewed from the lowermost layer under the above conditions and forming an ITO layer as the uppermost layer in the same manner as in Example A2. For the ITO layer as the uppermost layer, the particle diameter of the crystalline secondary particles and the number of crystalline secondary particles were measured and were found to be 0.8 μm and 15 particles/μm², respectively. The half-width value in the maximum peak of the crystal phase was 2.50. In order to form a 15-μm line by photolithography, the ITO layer was patterned with an etching liquid. As a result, the residue of the ITO particles was not observed under an optical microscope, and good patterning could be realized.

### Example A6

A gas barrier film with a transparent electroconductive membrane was formed by forming an assembly having a layer construction of base material film/gas barrier layer (SiOx) as viewed from the lowermost layer under the above conditions and forming an ITO layer as the uppermost layer in the same manner as in Example A3. For the ITO layer as the uppermost layer, the particle diameter of the crystalline secondary particles and the number of crystalline secondary particles were measured and were found to be 0.5 μm and 30 particles/μm², respectively. The half-width value in the maximum peak of the crystal phase was 5.42. In order to form a 15-μm line by photolithography, the ITO layer was patterned with an etching liquid. As a result, the residue of the ITO particles was not observed under an optical microscope, and good patterning could be realized.

### Example A7

An assembly having a layer construction of base material film/gas barrier layer (SiON)/smoothing layer (heat cured resin layer) as viewed from the lowermost layer was formed under the above conditions, and an ITO layer was formed as the uppermost layer in the same manner as in Example A1 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.3 μm and 5 particles/μm², respectively. The half-width value in the maximum peak of the crystal phase was 3.86. In order to form a 15-μm line by photolithography, the ITO layer was patterned with an etching liquid. As a result, the residue of the ITO particles was not observed under an optical microscope, and good patterning could be realized.

### Example A8

An assembly having a layer construction of base material film/gas barrier layer (SiOx)/smoothing layer (UV cured resin layer) as viewed from the lowermost layer was formed under the above conditions, and an ITO layer was formed as the uppermost layer in the same manner as in Example A2 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.8 μm and 15 particles/μm², respectively. The half-width value in the maximum peak of the crystal phase was 5.27. In order to form a 15-μm line by photolithography, the ITO layer was patterned with an etching liquid. As a result, the residue of the ITO particles was not observed under an optical microscope, and good patterning could be realized.

### Example A9

An assembly having a layer construction of base material film/gas barrier layer (SiOx)/smoothing layer (sol-gel layer) as viewed from the lowermost layer was formed under the above conditions, and an ITO layer was formed as the uppermost layer in the same manner as in Example A3 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.5 μm and 30 particles/μm², respectively. The half-width value in the maximum peak of the crystal phase was 2.64. In order to form a 15-μm line by photolithography, the ITO layer was patterned with an etching liquid. As a result, the residue of the ITO particles was not observed under an optical microscope, and good patterning could be realized.

### Example A10

An assembly having a layer construction of gas barrier layer (SiON)/base material film/gas barrier layer (SiON)/smoothing layer (heat cured resin layer)/gas barrier layer (SiON) as viewed from the lowermost layer was formed under the above conditions, and an ITO layer was formed as the uppermost layer in the same manner as in Example A1 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.3 μm and 5 particles/μm², respectively. The half-width value in the maximum peak of the crystal phase was 6.24. In order to form a 15-μm line by photolithography, the ITO layer was patterned with an etching liquid. As a result, the residue of the ITO particles was not observed under an optical microscope, and good patterning could be realized.

### Example A11

An assembly having a layer construction of gas barrier layer (SiOx)/base material film/gas barrier layer (SiOx)/smoothing layer (heat cured resin layer)/gas barrier layer (SiOx) as viewed from the lowermost layer was formed under the above conditions, and an ITO layer was formed as the uppermost layer in the same manner as in Example A2 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.8 μm and 15 particles/μm², respectively. The half-width value in the maximum peak of the crystal phase was 5.87. In order to form a 15-1 μm line by photolithography, the ITO layer was patterned with an etching liquid. As a result, the residue of the ITO particles was not observed under an optical microscope, and good patterning could be realized.

### Example A12

An assembly having a layer construction of gas barrier layer (SiOC)/base material film/gas barrier layer (SiOC)/smoothing layer (sol-gel layer)/gas barrier layer (SiOC) as viewed from the lowermost layer was formed under the above conditions, and an ITO layer was formed as the uppermost layer in the same manner as in Example A1 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.5 μm and 30 particles/μm², respectively. The half-width value in the maximum peak of the crystal phase was 4.84. In order to form a 15-μm line by photolithography, the ITO layer was patterned with an etching liquid. As a result, the residue of the ITO particles was not observed under an optical microscope, and good patterning could be realized.

### Example A13

An assembly having a layer construction of gas barrier layer (SiOC)/smoothing layer (sol-gel layer)/gas barrier layer (SiOx)/base material film/gas barrier layer (SiOx)/smoothing layer (sol-gel layer)/gas barrier layer (SiOC) as viewed from the lowermost layer was formed under the above conditions, and an ITO layer was formed as the uppermost layer in the same manner as in Example A1 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.3 μm and 5 particles/μm², respectively. The half-width value in the maximum peak of the crystal phase was 5.31. In order to form a 15-μm line by photolithography, the ITO layer was patterned with an etching liquid. As a result, the residue of the ITO particles was not observed under an optical microscope, and good patterning could be realized.

### Example A14

An assembly having a layer construction of gas barrier layer (SiON)/smoothing layer (UV cured resin layer)/gas barrier layer (SiOx)/base material film/gas barrier layer (SiOx)/smoothing layer (UV cured resin layer)/gas barrier layer (SiON) as viewed from the lowermost layer was formed under the above conditions, and an ITO layer was formed as the uppermost layer in the same manner as in Example AA2 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.8 μm and 15 particles/μm², respectively. The half-width value in the maximum peak of the crystal phase was 3.49. In order to form a 15-μm line by photolithography, the ITO layer was patterned with an etching liquid. As a result, the residue of the ITO particles was not observed under an optical microscope, and good patterning could be realized.

### Example A15

An assembly having a layer construction of gas barrier layer (SiON)/smoothing layer (heat cured resin layer)/gas barrier layer (SiOx)/base material film/gas barrier layer (SiOx)/smoothing layer (heat cured resin layer)/gas barrier layer (SiON) as viewed from the lowermost layer was formed under the above conditions, and an ITO layer was formed as the uppermost layer in the same manner as in Example A3 to form a gas barrier film with a transparent electroconductive membrane, comprising an ITO layer as the uppermost layer. For the ITO layer, the particle diameter of the crystalline secondary particles and the number of crystalline secondary particles were measured and were found to be 0.5 μm and 30 particles/μm², respectively. The half-width value in the maximum peak of the crystal phase was 4.45. In order to form a 15-μm line by photolithography, the ITO layer was patterned with an etching liquid. As a result, the residue of the ITO particles was not observed under an optical microscope, and good patterning could be realized.

### Example A16

A resist agent “OFRP-800” (tradename, manufactured by Tokyo Ohka Kogyo Co., Ltd.) was coated on an indium tin oxide in a gas barrier film with a transparent electroconductive membrane produced in Example A14, and the coating was patterned by photolithography to form a transparent electrode layer with a stripe pattern having a width of 0.094 mm, a gap of 0.016 mm, and a layer thickness of 100 nm at positions corresponding to fluorescence conversion layers of respective colors. Thus, a substrate for a display of Example A15 having a layer construction of gas barrier layer (SiON)/smoothing layer (UV cured resin layer)/gas barrier layer (SiOx)/base material film/gas barrier layer (SiOx)/smoothing layer (UV cured resin layer)/gas barrier layer (SiON)/transparent electrode layer (ITO) was produced.

The properties of the substrate for a display thus obtained were evaluated. As a result, it was found that the water vapor permeability and the oxygen permeability were not more than 0.01 g/m²·day and not more than 0.01 cc/m²·day·atm, respectively, that is, the gas barrier properties were satisfactory, and neither significant elongation nor deflection was observed.

### Example A17

A substrate for a display was produced in the same manner as in Example A16, except that the gas barrier film produced in Example A15 was used.

The properties of the substrate for a display thus obtained were evaluated. As a result, it was found that the water vapor permeability and the oxygen permeability were not more than 0.01 g/m²·day and not more than 0.01 cc/m²·day·atm, respectively, that is, the gas barrier properties were satisfactory, and neither significant elongation nor deflection was observed.

### Example A18

A liquid crystal display (LCD) was produced using the substrate for a display produced in Example 8 by adopting well-known technique and construction. The LCD display was continuously driven for 100 hr. As a result, good display could be realized without any problem.

### Example A19

(1) A 200 μm-thick sheet-like (30 cm×21 cm) polycarbonate (PC) film having a load flexing temperature of 160° C. was provided as a substrate 11.

(2) Formation of Blue Color Filter Layer

A blue filter material (Color Mosaic CB-7001: tradename, manufactured by Fuji-Hunt Electronics Technology Co., Ltd.) was spin coated on the polycarbonate (PC) film. The coating was patterned by photolithography to form a blue color filter layer having a stripe pattern having a line width of 0.1 mm, a pitch (period) of 0.33 mm, and a layer thickness of 6 μm.

(3) Formation of Green Conversion Layer

Coumarin 6 (0.7 part by mass) as a fluorescent dye was dissolved in 120 parts by mass of propylene glycol monoethyl acetate (PEGMA) as a solvent. “V259PA/P5” (tradename, manufactured by Nippon Steel Chemical Co., Ltd.) (100 parts by mass) as a photopolymerizable resin was added to and dissolved in the resultant solution to prepare a coating solution.

The coating solution prepared above was spin coated on the transparent support substrate with a blue color filter layer formed thereon produced above, followed by patterning by photolithography to form a green conversion layer with a stripe pattern having a line width of 0.1 mm, a pitch (period) of 0.33 mm, and a layer thickness of 10 μm.

(4) Formation of Red Conversion Layer

Coumarin 6 (0.6 part by mass), Rhodamine 6G (0.3 part by mass), and Basic Violet 11 (0.3 part by mass) as fluorescent dyes were dissolved in 120 parts by mass of propylene glycol monoethyl acetate (PEGMA) as a solvent. “V259PA/P5” (tradename, manufactured by Nippon Steel Chemical Co., Ltd.) (100 parts by mass) as a photopolymerizable resin was added to and dissolved in the resultant solution to prepare a coating solution.

The coating solution prepared above was spin coated on the transparent support substrate with a blue color filter layer and a green conversion layer formed thereon produced above, followed by patterning by photolithography to form a red conversion layer with a stripe pattern having a line width of 0.1 mm, a pitch (period) of 0.33 mm, and a layer thickness of 10 μm.

For each color conversion layer formation, line-shaped patterns of the red conversion layer, the green conversion layer, and the blue color filter layer formed as described above were arranged parallel to each other at a spacing width between mutual layers of 0.01 mm.

(5) Formation of Gas Barrier Layer and Smoothing Layer

Example 15 was repeated to form individual layers successively on both sides of the base material including the color conversion layers formed by the previous step to produce an assembly having a layer construction of gas barrier layer (SiON)/smoothing layer (heat cured resin layer)/gas barrier layer (SiOx)/base material film/gas barrier layer (SiOx)/smoothing layer (heat cured resin layer)/gas barrier layer (SiON).

(6) Formation of Transparent Electrode Layer

A transparent electrode (indium tin oxide) was formed by sputtering on the whole surface of the gas barrier layer (SiON). A resist agent “OFRP-800” (tradename, manufactured by Tokyo Ohka Kogyo Co., Ltd.) was coated on the indium tin oxide, and the coating was patterned by photolithography to form a transparent electrode layer having a stripe pattern of width 0.094 mm, spacing 0.016 mm, and layer thickness 100 nm as positions corresponding to the fluorescent conversion layers of respective colors.

(7) Formation of Organic EL Related Layers

A hole injection layer, a hole transport layer, an organic luminescent layer, and an electron injection layer were successively formed within a resistance heating type vapor deposition apparatus on the whole surface of the transparent electrode layer without breaking the vacuum. In the film formation, the internal pressure of the vacuum tank was reduced to 1×10⁻⁴ Pa. Copper phthalocyanine (CuPc) was stacked as the hole injection layer to a thickness of 100 nm. A layer of 4,4′-bis[N-(1-naphthyl)-N-phenylamino]biphenyl (—NPD) was stacked as the hole transport layer to a thickness of 20 nm. A layer of 4,4′-bis(2,2′-diphenylvinyl)biphenyl (DPVBi) was stacked as the organic luminescent layer to a thickness of 30 nm. An aluminum chelate (tris(8-hydroxyquinoline)aluminum complex, Alq) was stacked as the electron injection layer to a thickness of 20 nm.

Next, a cathode formed of a 200 nm-thick Mg/Ag (mass ratio 10/1) layer was formed using a mask for forming a pattern having a width of 0.30 mm and a spacing of 0.03 mm orthogonal to the stripe pattern of the anode (transparent electrode layer) without breaking the vacuum. The organic EL element thus obtained was sealed with a sealing glass and a UV curable adhesive under a dried nitrogen atmosphere (not more than 10 ppm for both oxygen and water concentrations) within a glove box to form an organic EL color display having a layer construction of gas barrier layer (SiON)/smoothing layer (heat cured resin layer)/gas barrier layer (SiOx)/base material film/gas barrier layer (SiOx)/smoothing layer (heat cured resin layer)/gas barrier layer (SiON)/transparent electrode layer/hole injection layer/hole transport layer/organic luminescent layer/electron injection layer/cathode.

The organic EL color display was continuously driven well for 100 hr without any problem.

### Comparative Example A1

A film with a transparent electroconductive membrane was formed in the same manner as in Example 1, except that the film thickness for each thin film formation was 0.1 nm and the number of times of repetition was 1500. The ITO film as the uppermost layer was analyzed. As a result, the presence of crystalline secondary particles could not be observed.

### Comparative Example A2

A film with a transparent electroconductive membrane was formed in the same manner as in Example 3, except that the substrate temperature was −10° C. The ITO film as the uppermost layer was analyzed. As a result, the diameter of the crystalline secondary particles and the number of the crystalline secondary particles were 5.0 μm and 3 particles/μm² respectively

Evaluation

For evaluation of each Examples and Comparative Example, the particle diameter and the water vapor permeability and oxygen permeability in a gas barrier film form and an organic EL element form were measured by the following measuring methods, and the results are shown in Table A1 and described in the present specification. In Table A1, The Examples are Examples A1 to A15, and the Comparative Examples are Comparative Examples A1 and A2.

The particle diameter was measured in a measuring range of 4 μm by visual observation with Nanopics 1000 manufactured by Seiko Instruments Inc.

The water vapor permeability was measured with a water permeability measuring apparatus (manufactured by MOCON, USA, PERMAT RAN-W 3/31: tradename) under conditions of measuring temperature 37.8° C. and humidity 100% Rh. The detection limit was 0.01 g/m²·day. When the measured value was less than the detection limit, the result was expressed as not more than 0.01 g/m²/day.

The oxygen permeability was measured with an oxygen gas permeability measuring apparatus (manufactured by MOCON, USA, OX-TRAN 2/20: tradename) under conditions of measuring temperature 23° C. and humidity 90% Rh. The detection limit was 0.01 cc/m²·day·atm. When the measured value was less than the detection limit, the result was expressed as not more than 0.01 cc/m²/day. When the measured value was not less than the maximum detection limit, the results was expressed as (−).

TABLE A1

| | Water vapor | Oxygen | Surface | Surface |
|---|---|---|---|---|
| | permeability, | permeability, | roughness, | resistivity, |
| | g/m² · day | cc/g/m² · day · atm | nm | Ω/□ |
| Ex. 1 | — | — | 1.03 | 35 |
| Ex. 2 | — | — | 1.32 | 44 |
| Ex. 3 | — | — | 0.96 | 21 |
| Ex. 4 | 0.36 | 0.43 | 0.99 | 34 |
| Ex. 5 | 0.48 | 0.56 | 1.45 | 43 |
| Ex. 6 | 0.32 | 0.26 | 0.86 | 19 |
| Ex. 7 | 0.03 | 0.03 | 1.02 | 37 |
| Ex. 8 | 0.05 | 0.06 | 1.65 | 45 |
| Ex. 9 | 0.03 | 0.05 | 0.88 | 20 |
| Ex. 10 | 0.01 | 0.01 | 0.98 | 35 |
| Ex. 11 | 0.01 | 0.01 | 0.98 | 43 |
| Ex. 12 | 0.01 | 0.01 | 0.91 | 21 |
| Ex. 13 | 0.01 | 0.01 | 1.06 | 36 |
| Ex. 14 | 0.01 | 0.01 | 1.54 | 44 |
| Ex. 15 | 0.01 | 0.01 | 0.88 | 20 |
| Comp. Ex. 1 | — | — | 0.56 | 75 |
| Comp. Ex. 2 | — | — | 4.23 | 15 |

(Summary of Evaluation Results)

For the gas barrier films produced in Examples A4 to A9, the water vapor permeability and the oxygen permeability were 0.03 to 0.48 g/m²·day and 0.03 to 0.56 cc/m²·day·atm, respectively, and, for the gas barrier films produced in Examples A10 to A15, the water vapor permeability and the oxygen permeability were not more than 0.01 g/m²·day and not more than 0.01 cc/m²·day·atm, respectively. That is, the gas barrier films had satisfactory gas barrier properties and did not have significant elongation and deflection.

As can be seen from the results of the evaluation on the properties of the gas barrier films produced in Comparative Examples A1 and A2, the products produced in Comparative Examples A1 and A2 did not meet requirements for use in display substrates, because the product in Comparative Example A1 had a high surface resistivity and the product in Comparative Example A2 had a large surface roughness.

### Example B

The second invention is further illustrated by the following Examples and Comparative Examples that are not intended as a limitation of the invention.

Materials and formation methods for individual layers used in the Examples and Comparative Examples will be summarized.

(1) Base Material:

“Polyethylene naphthalate” (manufactured by Teijin Ltd., Teonex Q65 (100 μm)) was used as a base material in the Examples.

(2) Smoothing Layer:

In the Examples and Comparative Examples, a smoothing layer 14 was formed as follows.

A sol-gel layer used as a smoothing layer was formed by spin coating a coating agent composed mainly of an aminoalkyltrialkoxysilane, drying the coating on a hot plate at 120° C. for two min and then in an oven at 160° C. for one hr to form a 1 μm-thick sol-gel layer (a flattening layer).

An UV cured resin layer used as a smoothing layer was formed by coating a UV cured acrylate (pentaerythritol tri(meth)acrylate) containing a photopolymerization initiator added thereto, drying the coating at 120° C. for two min, and then applying ultraviolet light (UV) with a high pressure mercury lamp to cure the coating by UV irradiation to form a 2 μm-thick smoothing layer.

A smoothing layer formed of a heat cured resin was formed by spin coating a coating agent V-259-EH (manufactured by Nippon Steel Chemical Co., Ltd., tradename), drying the coating at 120° C. for two min, and further drying the coating by hot air at 160° C. for 60 min to form a 1 μm-thick smoothing layer.

(3) Gas Barrier Layer:

Gas barrier layers 13 of the Examples and the Comparative Examples were formed as follows.

A gas barrier layer of SiOx (x=1.0 to 2.0) was formed by placing the assembly in a film forming chamber in a magnetron sputtering apparatus and conducting magnetron sputtering using silicon as a target under the following film forming conditions to form a gas barrier layer having a silicon oxide thickness of 100 nm.

<Conditions for Film Formation>

Film forming pressure: 2.7×10⁻¹ Pa

Argon gas flow rate: 30 sccm

Oxygen gas flow rate: 10 sccm

Applied voltage: 2.0 kW

A gas barrier layer of SiON was formed by placing the assembly in a film forming chamber in a magnetron sputtering apparatus and conducting magnetron sputtering using silicon nitride as a target under the following film forming conditions to form a gas barrier layer having a silicon oxynitride thickness of 100 nm.

<Conditions for Film Formation>

Film forming pressure: 2.5×10⁻¹ Pa

Argon gas flow rate: 30 sccm

Oxygen gas flow rate: 5 sccm

RF power supply frequency: 13.56 MHz

Applied voltage: 1.2 kW

A gas barrier layer of SiOC was formed by placing the assembly in a film forming chamber in a plasma CVD apparatus and conducting plasma CVD using hexamethyldisiloxane (HMDSO) as a starting material gas under the following film forming conditions to form gas barrier layer having a silicon oxycarbide thickness of 100 nm.

<Conditions for Film Formation>

Film forming pressure: 10 Pa

Argon gas flow rate: 10 sccm

Oxygen gas flow rate: 30 sccm

RF power supply frequency: 13.56 MHz

Applied voltage: 1.8 kW

A gas barrier layer of SiNC was formed by placing the assembly in a film forming chamber in a plasma CVD apparatus and conducting plasma CVD using HMDSN as a starting material gas under the following film forming conditions to form gas barrier layer having a silicon oxycarbide thickness of 100 nm.

<Conditions for Film Formation>

Film forming pressure: 10 Pa

Argon gas flow rate: 10 sccm

Nitrogen gas flow rate: 20 sccm

RF power supply frequency: 13.56 MHz

Applied voltage: 1.2 kW

(4) Smoothing Layer:

In the Examples and Comparative Examples, a smoothing layer 14 was formed as follows.

A sol-gel layer used as a smoothing layer was formed by spin coating a coating agent composed mainly of an aminoalkyltrialkoxysilane, drying the coating on a hot plate at 120° C. for two min and then in a drier at 160° C. for one hr to form a 1 μm-thick sol-gel layer (a flattening layer).

A UV cured resin layer used as a smoothing layer was formed by coating a UV cured acrylate containing a photopolymerization initiator added thereto, drying the coating on a hot plate at 120° C. for two min, and then applying ultraviolet light (UV) with a high pressure mercury lamp to cure the coating by UV irradiation to form a 2 μm-thick smoothing layer.

A cardo polymer layer used as a smoothing layer was formed by spin coating a coating agent composed mainly of a cardo polymer, i.e., V-259-EH (manufactured by Nippon Steel Chemical Co., Ltd., tradename), drying the coating at 120° C. for two min, and further drying the coating by hot air at 160° C. for 60 min to form a 1 μm-thick smoothing layer.

### Example B1

A 0.5 nm-thick ITO film was formed on a base material by magnetron sputtering using a DC power supply under conditions of electric power 2 kW and Ar gas 500 sccm. Plasma treatment was then carried out using a DC power supply under conditions of electric power 1 kW, Ar 300 sccm, and oxygen 100 sccm for 15 sec. These two steps were repeated 300 times to form a 150 nm-thick ITO film. For the ITO film, the average particle diameter of the crystalline particles and the number of crystalline particles were measured and were found to be 0.3 μm and 5 particles/μm², respectively.

### Example B2

A 0.5 nm-thick ITO film was formed on a base material by a resistance heating-type vacuum deposition method. Plasma treatment was then carried out using a DC power supply under conditions of electric power 1 kW, Ar 200 sccm, and oxygen 500 sccm for 15 sec. These two steps were repeated 300 times to form a 150 nm-thick ITO film. For the ITO film, the particle diameter of the crystalline particles and the number of crystalline particles were measured and were found to be 0.8 μm and 15 particles/μm², respectively.

### Example B3

A 0.5 nm-thick ITO film was formed on a base material by ion plating under conditions of electric power 5 kW and Ar gas 500 sccm. Plasma treatment was then carried out using a DC power supply under conditions of electric power 1 kW, Ar 100 sccm, and oxygen 10 sccm for 15 sec. These two steps were repeated 300 times to form a 150 nm-thick ITO film. For the ITO film, the particle diameter of the crystalline particles and the number of crystalline particles were measured and were found to be 0.5 μm and 30 particles/μm², respectively.

### Example B4

A gas barrier film with a transparent electroconductive membrane was formed by forming an assembly having a layer construction of base material film/gas barrier layer (SiOx) as viewed from the lowermost layer under the above conditions and forming an ITO layer as the uppermost layer in the same manner as in Example B1.

### Example B5

A gas barrier film with a transparent electroconductive membrane was formed by forming an assembly having a layer construction of base material film/gas barrier layer (SiON) as viewed from the lowermost layer under the above conditions and forming an ITO layer as the uppermost layer in the same manner as in Example B2.

### Example B6

A gas barrier film with a transparent electroconductive membrane was formed by forming an assembly having a layer construction of base material film/gas barrier layer (SiOC) as viewed from the lowermost layer under the above conditions and forming an ITO layer as the uppermost layer in the same manner as in Example B3.

### Example B7

A gas barrier film with a transparent electroconductive membrane was formed by forming an assembly having a layer construction of base material film/smoothing layer (sol-gel layer) as viewed from the lowermost layer under the above conditions and forming an ITO layer as the uppermost layer in the same manner as in Example B1.

### Example B8

A gas barrier film with a transparent electroconductive membrane was formed by forming an assembly having a layer construction of base material film/smoothing layer (UV cured resin layer) as viewed from the lowermost layer under the above conditions and forming an ITO layer as the uppermost layer in the same manner as in Example B2.

### Example B9

A gas barrier film with a transparent electroconductive membrane was formed by forming an assembly having a layer construction of base material film/smoothing layer (heat cured resin layer) as viewed from the lowermost layer under the above conditions and forming an ITO layer as the uppermost layer in the same manner as in Example B3.

### Example B10

An assembly having a layer construction of gas barrier layer (SiNC)/base material film/gas barrier layer (SiOx)/smoothing layer (sol-gel layer)/gas barrier layer (SiON) as viewed from the lowermost layer was formed under the above conditions, and an ITO layer was formed as the uppermost layer in the same manner as in Example B1 to form a gas barrier film with a transparent electroconductive membrane, comprising an ITO layer as the uppermost layer.

### Example B11

An assembly having a layer construction of gas barrier layer (SiOC)/base material film/gas barrier layer (SiNC)/smoothing layer (UV cured resin layer)/gas barrier layer (SiOx) as viewed from the lowermost layer was formed under the above conditions, and an ITO layer was formed as the uppermost layer in the same manner as in Example B2 to form a gas barrier film with a transparent electroconductive membrane, comprising an ITO layer as the uppermost layer.

### Example B12

An assembly having a layer construction of gas barrier layer (SiON)/base material film/gas barrier layer (SiOC)/smoothing layer (heat cured resin layer)/gas barrier layer (SiNC) as viewed from the lowermost layer was formed under the above conditions, and an ITO layer was formed as the uppermost layer in the same manner as in Example B1 to form a gas barrier film with a transparent electroconductive membrane, comprising an ITO layer as the uppermost layer.

### Example B13

An assembly having a layer construction of gas barrier layer (SiOC)/smoothing layer (sol-gel layer)/gas barrier layer (SiOC)/base material film/gas barrier layer (SiOC)/smoothing layer (sol-gel layer)/gas barrier layer (SiOC) as viewed from the lowermost layer was formed under the above conditions, and an ITO layer was formed as the uppermost layer in the same manner as in Example B1 to form a gas barrier film with a transparent electroconductive membrane, comprising an ITO layer as the uppermost layer.

### Example B14

An assembly having a layer construction of gas barrier layer (SiOx)/smoothing layer (UV cured resin layer)/gas barrier layer (SiOx)/base material film/gas barrier layer (SiOx)/smoothing layer (UV cured resin layer)/gas barrier layer (SiOx) as viewed from the lowermost layer was formed under the above conditions, and an ITO layer was formed as the uppermost layer in the same manner as in Example B2 to form a gas barrier film with a transparent electroconductive membrane, comprising an ITO layer as the uppermost layer.

### Example B15

An assembly having a layer construction of gas barrier layer (SiON)/smoothing layer (heat cured resin layer)/gas barrier layer (SiON)/base material film/gas barrier layer (SiON)/smoothing layer (heat curing resin layer)/gas barrier layer (SiON) as viewed from the lowermost layer was formed under the above conditions, and an ITO layer was formed as the uppermost layer in the same manner as in Example B3 to form a gas barrier film with a transparent electroconductive membrane, comprising an ITO layer as the uppermost layer.

### Example B16

A resist agent “OFRP-800” (tradename, manufactured by Tokyo Ohka Kogyo Co., Ltd.) was coated on an indium tin oxide in a gas barrier film with a transparent electroconductive membrane produced in Example B14, and the coating was patterned by photolithography to form a transparent electrode layer with a stripe pattern having a width of 0.094 mm, a gap of 0.016 mm, and a layer thickness of 100 nm at positions corresponding to fluorescence conversion layers of respective colors. Thus, a substrate for a display produced in Example B14 having a layer construction of gas barrier layer (SiOx)/smoothing layer (UV curing resin layer)/gas barrier layer (SiOx)/base material film/gas barrier layer (SiOx)/smoothing layer (UV curing resin layer)/gas barrier layer (SiOx)/transparent electrode layer (ITO) was produced.

The properties of the substrate for a display thus obtained were evaluated. As a result, it was found that the water vapor permeability and the oxygen permeability were not more than 0.01 g/m²·day and not more than 0.01 cc/m²·day·atm, respectively, the gas barrier properties were satisfactory, and neither significant elongation nor deflection was observed.

### Example B17

A substrate for a display was produced in the same manner as in Example 16, except that the gas barrier film produced in Example 15 was used.

The properties of the substrate for a display thus obtained were evaluated. As a result, it was found that the water vapor permeability and the oxygen permeability were not more than 0.01 g/m²·day and not more than 0.01 cc/m²·day·atm, respectively, the gas barrier properties were satisfactory, and neither significant elongation nor deflection was observed.

### Example B18

A liquid crystal display (LCD) was produced using the substrate for a display produced in Example B14 by adopting well-known technique and construction. The LCD display was continuously driven for 100 hr. As a result, good display could be realized without any problem.

### Example B19

(1) A 200 μm-thick sheet-like (30 cm×21 cm) polycarbonate (PC) film having a load flexing temperature of 160° C. was provided as a substrate 10.

(2) Formation of Blue Color Filter Layer

A blue filter material (Color Mosaic CB-7001: tradename, manufactured by Fuji-Hunt Electronics Technology Co., Ltd.) was spin coated on the polycarbonate (PC) film. The coating film was patterned by photolithography to form a blue color filter layer having a stripe pattern having a line width of 0.1 mm, a pitch (period) of 0.33 mm, and a layer thickness of 6 μm.

(3) Formation of Green Conversion Layer

Coumarin 6 (0.7 part by mass) as a fluorescent dye was dissolved in 120 parts by mass of propylene glycol monoethyl acetate (PEGMA) as a solvent. “V259PA/P5” (tradename, manufactured by Nippon Steel Chemical Co., Ltd.) (100 parts by mass) as a photopolymerizable resin was added to and dissolved in the resultant solution to prepare a coating solution.

The coating solution prepared above was spin coated on the transparent support substrate with a blue color filter layer formed thereon produced in the above step, followed by patterning by photolithography to form a green conversion layer with a stripe pattern having a line width of 0.1 mm, a pitch (period) of 0.33 mm, and a layer thickness of 10 μm.

(4) Formation of Red Conversion Layer

Coumarin 6 (0.6 part by mass), Rhodamine 6G (0.3 part by mass), and Basic Violet 11 (0.3 part by mass) as fluorescent dyes were dissolved in 120 parts by mass of propylene glycol monoethyl acetate (PEGMA) as a solvent. “V259PA/P5” (tradename, manufactured by Nippon Steel Chemical Co., Ltd.) (100 parts by mass) as a photopolymerizable resin was added to and dissolved in the resultant solution to prepare a coating solution.

The coating solution prepared above was spin coated on the transparent support substrate with a blue color filter layer and a green conversion layer formed thereon, followed by patterning by photolithography to form a red conversion layer with a stripe pattern having a line width of 0.1 mm, a pitch (period) of 0.33 mm, and a layer thickness of 10 μm.

For each color conversion layer formation, line-shaped patterns of the red conversion layer, the green conversion layer, and the blue color filter layer formed as described above were arranged parallel to each other at a spacing width between mutual layers of 0.01 mm.

(5) Formation of Gas Barrier Layer and Smoothing Layer

Example 15 was repeated to form individual layers successively on both sides of the base material including the color conversion layers formed by the previous step to produce an assembly having a layer construction of (SiON)/smoothing layer (heat curing resin layer)/gas barrier layer (SiON)/base material film/gas barrier layer (SiON)/smoothing layer (heat curing resin layer)/gas barrier layer (SiON).

(6) Formation of Transparent Electrode Layer

A transparent electrode (indium tin oxide) was formed by sputtering on the whole surface of the gas barrier layer (SiON). A resist agent “OFRP-800” (tradename, manufactured by Tokyo Ohka Kogyo Co., Ltd.) was coated on the indium tin oxide, and the coating was patterned by photolithography to form a transparent electrode layer having a stripe pattern of width 0.094 mm, spacing 0.016 mm, and layer thickness 100 nm at positions corresponding to the fluorescent conversion layers of respective colors.

(7) Formation of Organic EL Related Layers

A hole injection layer, a hole transport layer, an organic luminescent layer, and an electron injection layer were successively formed within a resistance heating type vapor deposition apparatus on the whole surface of the transparent electrode layer without breaking the vacuum. In the film formation, the internal pressure of the vacuum tank was reduced to 1×10⁻⁴ Pa. Copper phthalocyanine (CuPc) was stacked as the hole injection layer to a thickness of 100 nm. A layer of 4,4′-bis[N-(1-naphthyl)-N-phenylamino]biphenyl (—NPD) was stacked as the hole transport layer to a thickness of 20 nm. A layer of 4,4′-bis(2,2′-diphenylvinyl)biphenyl (DPVBi) was stacked as the organic luminescent layer to a thickness of 30 nm. An aluminum chelate (tris(8-hydroxyquinoline)aluminum complex, Alq) was stacked as the electron injection layer to a thickness of 20 nm.

Next, a cathode formed of a 200 nm-thick Mg/Ag (mass ratio 10/1) layer was formed using a mask for forming a pattern having a width of 0.30 mm and a spacing of 0.03 mm orthogonal to the stripe pattern of the anode (transparent electrode layer) without breaking the vacuum. The organic EL element thus obtained was sealed with a sealing glass and a UV curable adhesive under a dried nitrogen atmosphere (not more than 10 ppm for both oxygen and water concentrations) within a glove box to form an organic EL color display having a layer construction of (SiON)/smoothing layer (heat curing resin layer)/gas barrier layer (SiON)/base material film/gas barrier layer (SiON)/smoothing layer (heat curing resin layer)/gas barrier layer (SiON)/base material film/color filter layer/gas barrier layer (SiON)/smoothing layer (heat curing resin layer)/gas barrier layer (SiON)/base material film/gas barrier layer (SiON)/smoothing layer (cardo polymer layer)/gas barrier layer (SiON)/transparent electrode layer/hole injection layer/hole transport layer/organic luminescent layer/electron injection layer/cathode.

The organic EL color display was continuously driven well for 100 hr without any problem.

### Comparative Example B1

A film with a transparent electroconductive membrane was formed in the same manner as in Example B1, except that the film thickness for each thin film formation was 0.1 nm and the number of times of repetition was 1500.

### Comparative Example B2

A film with a transparent electroconductive membrane was formed in the same manner as in Example B1, except that the film thickness for each thin film formation was 30 nm and the number of times of repetition was 5.

Evaluation

For evaluation of each Example and Comparative Example, the particle diameter and the water vapor permeability and oxygen permeability in a gas barrier film form and an organic EL element form were measured by the following measuring methods, and the results are shown in Table B1. In Table B1, The Examples are Examples B1 to B15, and the Comparative Examples are Comparative Examples B1 and B2.

The particle diameter was measured in a measuring range of 4 μm by visual observation with Nanopics 1000 manufactured by Seiko Instruments Inc.

The water vapor permeability was measured with a water permeability measuring apparatus (manufactured by MOCON, USA, PERMAT RAN-W 3/31: tradename) under conditions of measuring temperature 37.8° C. and humidity 100% Rh. The detection limit was 0.01 g/m²·day. When the measured value was less than the detection limit, the result was expressed as not more than 0.01 g/m²/day.

The oxygen permeability was measured with an oxygen gas permeability measuring apparatus (manufactured by MOCON, USA, OX-TRAN 2/20: tradename) under conditions of measuring temperature 23° C. and humidity 90% Rh. The detection limit was 0.01 cc/m²·day·atm. When the measured value was less than the detection limit, the result was expressed as not more than 0.01 cc/m²/day. When the measured value was not less than the maximum detection limit, the results was expressed as (−).

TABLE B1

| | Water vapor | Oxygen permeability, | Total light | | Extinction | Surface |
|---|---|---|---|---|---|---|
| | permeability, g/m² · day | cc/g/m² · day · atm | transmittance, % | Y1 | coefficient | resistivity, Ω/□ |
| Ex. 1 | — | — | 85.3 | 2.1 | 0.01 | 40 |
| Ex. 2 | — | — | 84.8 | 1.8 | 0.03 | 38 |
| Ex. 3 | — | — | 85.1 | 2.5 | 0.02 | 41 |
| Ex. 4 | 1.02 | 0.93 | 80.2 | 3.4 | 0.01 | 39 |
| Ex. 5 | 0.78 | 0.62 | 78.9 | 3.7 | 0.03 | 45 |
| Ex. 6 | 1.01 | 0.96 | 79.4 | 4.1 | 0.02 | 44 |
| Ex. 7 | 0.31 | 0.46 | 79.6 | 4.3 | 0.01 | 43 |
| Ex. 8 | 0.52 | 0.51 | 79.2 | 4.6 | 0.03 | 40 |
| Ex. 9 | 0.44 | 0.53 | 79.1 | 4.5 | 0.02 | 42 |
| Ex. 10 | 0.01 | 0.01 | 77.9 | 4.4 | 0.01 | 41 |
| Ex. 11 | 0.01 | 0.01 | 76.8 | 4.3 | 0.03 | 43 |
| Ex. 12 | 0.01 | 0.01 | 77.7 | 4.6 | 0.02 | 44 |
| Ex. 13 | 0.01 | 0.01 | 77.2 | 4.7 | 0.01 | 45 |
| Ex. 14 | 0.01 | 0.01 | 75.9 | 4.8 | 0.03 | 44 |
| Ex. 15 | 0.01 | 0.01 | 76.4 | 4.8 | 0.02 | 44 |
| Comp. Ex. 1 | — | — | 85.4 | 1.8 | 0.001 | 80 |
| Comp. Ex. 2 | — | — | 78.5 | 8.9 | 0.15 | 45 |

The values of the surface resistivity are those when the ITO film was formed in a thickness of 150 nm.

(Summary of Evaluation Results)

For the gas barrier films produced in Examples B4 to B9, the water vapor permeability and the oxygen permeability were 0.31 to 1.02 g/m²·day and 0.46 to 0.96 cc/m²·day·atm, respectively, and, for the gas barrier films produced in Examples 10 to 19, the water vapor permeability and the oxygen permeability were not more than 0.01 g/m²·day and not more than 0.01 cc/m²·day·atm, respectively. That is, the gas barrier films had satisfactory gas barrier properties and did not have significant elongation and deflection.

As can be seen from the results of the evaluation of the properties of the gas barrier films produced in Comparative Examples B1 and B2, the products produced in Comparative Examples B1 and B2 did not meet requirements for use in display substrates, because the product in Comparative Example B1 had a high surface resistivity of 80Ω/□, and the product in Comparative Example B2 had a YI value of 8.9, that is, was in a colored state.

1. A film with a transparent electroconductive membrane, comprising a transparent base material and a transparent electroconductive membrane, the transparent electroconductive membrane having on its surface crystalline secondary particles having an average particle diameter of 0.1 to 1 μm in an amount of 1 to 100 particles/μm².

2. The film with a transparent electroconductive membrane according to claim 1, wherein the transparent electroconductive membrane contains crystalline secondary particles having an average particle diameter of 0.1 to 1 μm in an amount of 150 to 10000 particles/μm³.

3. The film with a transparent electroconductive membrane according to claim 1, wherein, in the transparent electroconductive membrane, the half value width at the maximum peak angle in a crystal phase is 1.5 to 9.5.

4. The film with a transparent electroconductive membrane according to claim 1, which has an extinction coefficient against light with a wavelength of 550 nm of not more than 0.05 and a yellowness (YI) of 0.5 to 3.0.

5. A substrate for a display comprising a film with a transparent electroconductive membrane according to claim 1.

6. A display comprising a substrate for a display according to claim 5.

7. A liquid crystal display device comprising a substrate for a display according to claim 5.

8. An organic EL element comprising a substrate for a display according to claim 5.

9. A film with a transparent electroconductive membrane, comprising a transparent base material and a transparent electroconductive membrane, the extinction coefficient against light with a wavelength of 550 nm and the yellowness (YI) of the film with a transparent electroconductive membrane being not more than 0.05 and 0.5 to 3.0, respectively.

10. The film with a transparent electroconductive membrane according to claim 9, wherein the total light transmittance is not less than 75%.

11. The film with a transparent electroconductive membrane according to claim 9, wherein the transparent electroconductive membrane has been formed by repeating a plurality of times the step of conducting any one of plasma treatment, ion bombardment, glow discharge treatment, arc discharge treatment, and spray treatment in an oxidizing gas every time when each 0.3 to 10 nm-thick transparent electroconductive membrane is formed, and accumulating the transparent electroconductive thin film formed in each treatment.

12. The film with a transparent electroconductive membrane according to claim 9, which further comprises a first gas barrier layer.

13. The film with a transparent electroconductive membrane according to claim 12, which further comprises a first smoothing layer.

14. The film with a transparent electroconductive membrane according to claim 13, which further comprises a second gas barrier layer.

15. The film with a transparent electroconductive membrane according to claim 14, which further comprises a second smoothing layer.

16. The film with a transparent electroconductive membrane according to claim 13, wherein the first smoothing layer is formed of an ionization radiation cured resin.

17. The film with a transparent electroconductive membrane according to claim 14, wherein the first gas barrier layer and/or the second gas barrier layer are formed of any one material selected from the group consisting of inorganic oxides, inorganic oxynitrides, inorganic oxycarbides, or inorganic oxynitrocarbides.

18. The film with a transparent electroconductive membrane according to claim 15, wherein the first smoothing layer and/or the second smoothing layer are a layer containing a cardo polymer, a layer containing a polymer having an acryl skeleton, a layer, which is a coating film formed from a coating composition comprising as components at least a silane coupling agent containing an organic functional group and a hydrolyzable group, and a crosslinkable compound containing an organic functional group reactive with the organic functional group contained in the silane coupling agent, or a layer containing a polymer having an epoxy skeleton.

19. The film with a transparent electroconductive membrane according to claim 12, which has a water vapor permeability of not more than 0.05 g/m²/day.

20. A substrate for a display comprising a film with a transparent electroconductive membrane according to claim 9.

21. A display comprising a substrate for a display according to claim 20.

22. A liquid crystal display device comprising a substrate for a display according to claim 20.

23. An organic EL element comprising a substrate for a display according to claim 20.
